(19) United States
(12) Patent Application Publication
(10) Pub. No.: US 2014/0158082 A1
(43) Pub. Date: Jun. 12, 2014

(54) Crankpin including Cam, Connecting Rod including Follower, and Internal Combustion Engine including Crankpin and Connecting Rod

(71) Applicant: Larry C. Wilkins, Ft. Lauderdale, FL (US)

(72) Inventor: Larry C. Wilkins, Ft. Lauderdale, FL (US)

(21) Appl. No.: 13/993,727

(22) PCT Filed: Dec. 12, 2011
(86) PCT No.: PCT/US11/64448

§ 371 Date: Feb. 19, 2014

Related U.S. Application Data
(60) Provisional application No. 61/422,517, filed on Dec. 13, 2010.

(51) Int. Cl. F02B 75/32

(52) U.S. Cl. CPC F02B 75/32
USPC 123/197.4

(57) ABSTRACT

A crankshaft for an internal combustion engine may include first and second journals having circular cross-sections, wherein the first and second journals define a longitudinal crankshaft axis. The crankshaft may further include a crankpin defining a longitudinal crankpin axis and being configured to be coupled to a connecting rod, the crankpin extending between the first and second journals, such that the longitudinal crankpin axis is parallel to the longitudinal crankshaft axis. The crankpin may include at least one crankpin journal and at least one cam including a cam profile, wherein the cam profile is configured to affect the stroke of a connecting rod coupled to the crankpin. A connecting rod may include a follower configured to follow a cam. An internal combustion engine may include a crankshaft and a connecting rod configured to provide relative linear movement between a crankpin axis and a proximal end of the connecting rod.

### RELATED APPLICATION

This PCT International Application claims the right of priority to, and hereby incorporates by reference herein in its entirety, U.S. Provisional Patent Application No. 61/422,517, filed Dec. 13, 2010, and also claims the benefits of any rights of priority that may be available to this application.

### FIELD OF THE DISCLOSURE

The present disclosure relates to crankshafts, connecting rods, and internal combustion engines. In particular, the present disclosure relates to internal combustion engines with improved fuel efficiency and/or power output.

### BACKGROUND

High fuel costs and a desire to reduce undesirable emissions associated with operation of internal combustion engines has renewed interest in improving fuel efficiency during operation. Thus, it may be desirable to improve the efficiency of conventional internal combustion engines.

A conventional internal combustion engine includes a cylinder block defining journals for receiving a crankshaft and one or more cylinders housing a piston that is operably coupled to the crankshaft at a crankpin via a connecting rod. During conventional operation, the piston reciprocates within the cylinder, such that during a power stroke of the internal combustion engine, combustion of an air/fuel mixture within a combustion chamber defined by the piston, the cylinder, and a cylinder head forces the piston toward the crankshaft. As the piston travels toward the crankshaft, the crankshaft is rotated via the connecting rod and crankpin, thereby converting the energy associated with combustion of the air/fuel mixture into mechanical work.

Due to the architecture of a conventional internal combustion engine, when the piston is at a position within the cylinder that coincides with the maximum compression (i.e., the combustion chamber is at its lowest volume when the piston is farthest from the crankshaft), the radial axis extending between the center of the crankshaft and the center of the crankpin tends to be nearly co-linear, if not co-linear, with the axis of the connecting rod. At these relative positions, as the piston first begins its movement toward the crankshaft during the power stroke, there is only a very short moment arm (if any) created between the axis connecting rod and the radial axis. As a result, the force initially created by the air/fuel mixture at the moment of combustion does not transfer as much torque to the crankshaft as it would if the length of the moment arm were greater. This situation may be particularly undesirable because during combustion and very shortly thereafter, the force on the piston due to the combustion event approaches its maximum magnitude. Further, as the piston travels down the cylinder toward the crankshaft and the length of the moment arm increases, the magnitude of the force from the combustion event acting on the piston dissipates rapidly. Thus, because there is a very short moment arm created between the axis of the connecting rod and the radial axis during the time of maximum force on the piston, efficiency of the work generated from the combustion process may be less than desired.

Thus, it may be desirable to provide an internal combustion engine with a configuration that improves the efficiency of the internal combustion engine during operation. Further, it may be desirable to provide an internal combustion engine with a configuration that permits tailoring of desired performance characteristics.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to a crankshaft for an internal combustion engine. The crankshaft may include a first journal having a circular cross-section defining a first journal center, the first journal being configured to be rotatably coupled to a cylinder block of an internal combustion engine. The crankshaft may also include a second journal having a circular cross-section defining a second journal center, the second journal being configured to be rotatably coupled to a cylinder block of the internal combustion engine, wherein the first and second journal centers define a longitudinal crankshaft axis. The crankshaft may further include a crankpin defining a longitudinal crankpin axis and being configured to be coupled to a connecting rod, the crankpin extending between the first and second journals, such that the longitudinal crankpin axis is parallel to and spaced from the longitudinal crankshaft axis. The crankpin may include at least one crankpin journal and at least one cam including a cam profile, wherein the cam profile is configured to affect the stroke of a connecting rod coupled to the crankpin.

According to another aspect, a connecting rod for an internal combustion engine may include a rod portion and a cap portion, wherein the rod portion and the cap portion define an oblong opening configured to receive a crankpin of an internal combustion engine. An end of the oblong opening may be associated with a follower configured to follow a cam.

According to still a further aspect, an internal combustion engine may include a cylinder block defining a cylinder and a crankshaft including a crankpin, wherein the crankshaft is rotatably coupled to the cylinder block and rotates along a longitudinal crankshaft axis. The crankpin may define a longitudinal crankpin axis parallel to and spaced from the longitudinal crankshaft axis. The engine may further include a piston configured to reciprocate within the cylinder, and a connecting rod including a proximal end and a distal end, wherein the proximal end is operably coupled to the crankpin, and the distal end is operably coupled to the piston. The crankpin and connecting rod may be configured to provide relative linear movement between the longitudinal crankpin axis and the proximal end of the connecting rod.

According to yet another aspect, an internal combustion engine may include a cylinder block defining a cylinder and a crankshaft including a crankpin, wherein the crankshaft is rotatably coupled to the cylinder block and rotates along a longitudinal crankshaft axis. The crankpin may define a longitudinal crankpin axis parallel to and spaced from the longitudinal crankshaft axis. The engine may further include a piston configured to reciprocate within the cylinder and a connecting rod including a proximal end and a distal end, wherein the proximal end is operably coupled to the crankpin and the distal end is operably coupled to the piston. The crankpin and the connecting rod may be configured such that relative linear motion between the crankpin and the proximal end of the connecting rod results in a distance between the longitudinal crankpin axis and an upper surface of the piston being variable.

According to still a further aspect, an internal combustion engine may include a cylinder block defining a cylinder and a crankshaft including a crankpin, wherein the crankshaft is rotatably coupled to the cylinder block and rotates along a longitudinal crankshaft axis. The crankpin may define a longitudinal crankpin axis parallel to and offset by a distance with respect to the longitudinal crankshaft axis. The engine may further include a piston configured to reciprocate within the cylinder between spaced stroke termination points defining a stroke of the piston. The engine may also include a connecting rod including a proximal end and a distal end, wherein the proximal end is operably coupled to the crankpin and the distal end is operably coupled to the piston, wherein a line extending between the longitudinal crankshaft axis and the longitudinal crankpin axis defines a radial axis of the crankshaft. The crankpin and the proximal end of the connecting rod may be configured to vary a distance between the longitudinal crankpin axis and the distal end of the connecting rod. The engine may be configured, such that as the crankshaft rotates, reversal of the direction of travel of the piston within the cylinder is delayed via relative motion between the longitudinal crankpin axis and the proximal end of the connecting rod after the piston reaches at least one of the stroke termination points.

According to yet a further aspect, an internal combustion engine may include a cylinder block defining a cylinder and a crankshaft including a crankpin, wherein the crankshaft is rotatably received by the cylinder block and rotates along a longitudinal crankshaft axis. The crankpin may define a longitudinal crankpin axis parallel to and offset by a distance with respect to the longitudinal crankshaft axis. The engine may further include a piston configured to reciprocate within the cylinder and a connecting rod including a proximal end and a distal end, wherein the proximal end is operably coupled to the crankpin, and the distal end is operably coupled to the piston. A line extending between the longitudinal crankshaft axis and the longitudinal crankpin axis may define a radial axis of the crankshaft. The crankpin and the proximal end of the connecting rod may be configured to vary a distance between the longitudinal crankpin axis and the distal end of the connecting rod. The engine may be configured to selectively operate in two modes, including: a first mode, wherein the distance between the longitudinal crankpin axis and the distal end of the connecting rod varies according to a first strategy based on the radial position of the radial axis of the crankshaft, and a second mode, wherein the distance between the longitudinal crankpin axis and the distal end of the connecting rod varies according to a second strategy based on the radial position of the radial axis of the crankshaft. The first strategy may differ from the second strategy.

According to yet another aspect, a power train may include an internal combustion engine, a transmission operably coupled to the engine, and a drive member configured to perform work. The drive member may be operably coupled to the transmission.

According to still a further aspect, a vehicle may include an internal combustion engine, a transmission operably coupled to the engine, and a drive member configured to perform work. The drive member may be operably coupled to the transmission.

Additional objects and advantages of the disclosure will be set forth in part in the description which follows, or may be learned by practice of the disclosed embodiment.

Aside from the structural and procedural arrangements set forth above, the embodiment could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this description, illustrate exemplary embodiments and together with the description, serve to explain the principles of the embodiments. In the drawings,

FIG. 1 is a schematic partial perspective view of an exemplary embodiment of an internal combustion engine;

FIG. 2 is a schematic partial perspective view of a portion of the exemplary embodiment shown in FIG. 1;

FIG. 3 is a schematic side view of an exemplary embodiment of a crankshaft for the exemplary embodiment shown in FIG. 1;

FIG. 4 is a schematic exploded perspective view of an exemplary embodiment of a connecting rod for the exemplary embodiment shown in FIG. 1;

FIG. 5 is a schematic top view of the exemplary embodiment shown in FIG. 1;

FIG. 6 is a schematic partial perspective section view taken along line A-A of FIG. 5;

FIG. 7 is a schematic partial perspective section view taken along line B-B of FIG. 5;

FIG. 8 is a schematic partial end section view taken along line A-A of FIG. 5 with a radial axis angle of the crankshaft shown at 0 degrees;

FIG. 8A is a schematic detail view of a portion of FIG. 8;

FIG. 9 is a schematic partial end section view taken along line B-B of FIG. 5 with the radial axis angle of the crankshaft shown at 0 degrees;

FIG. 10 is a schematic partial end section view taken along line A-A of FIG. 5 with the radial axis angle of the crankshaft shown at 40 degrees;

FIG. 11 is a schematic partial end section view taken along line A-A of FIG. 5 with the radial axis angle of the crankshaft shown at 60 degrees;

FIG. 12 is a schematic partial end section view taken along line A-A of FIG. 5 with the radial axis angle of the crankshaft shown at 120 degrees;

FIG. 13 is a schematic partial end section view taken along line A-A of FIG. 5 with the radial axis angle of the crankshaft shown at 180 degrees;

FIG. 14 is a schematic partial end section view taken along line A-A of FIG. 5 with the radial axis angle of the crankshaft shown at 270 degrees;

FIG. 15 is a schematic partial end section view taken along line A-A of FIG. 5 with the radial axis angle of the crankshaft shown at 0/360 degrees;

FIG. 16 is a schematic partial perspective view of another exemplary embodiment of an internal combustion engine;

FIG. 17 is a schematic partial perspective view of a portion of the exemplary embodiment shown in FIG. 16;

FIG. 18 is a schematic perspective view of an exemplary embodiment of a crankshaft for the exemplary embodiment shown in FIG. 16;

FIG. 19 is a schematic perspective view of an exemplary embodiment of a connecting rod for the exemplary embodiment shown in FIG. 16;

FIG. 20 is a schematic top view of the exemplary embodiment shown in FIG. 16;

FIG. 21A is a schematic partial perspective section view taken along line A-A of FIG. 20;

FIG. 21B is a schematic partial perspective section view taken along line B-B of FIG. 20;

FIG. 22A is a schematic partial end section view taken along line A-A of FIG. 20 with a radial axis angle of the crankshaft shown at 0 degrees;

FIG. 22B is a schematic partial end section view taken along line B-B of FIG. 20 with the radial axis angle of the crankshaft shown at 0 degrees;

FIG. 22C is a schematic detail view of a portion of FIG. 22B;

FIG. 23A is a schematic partial end section view taken along line A-A of FIG. 20 with the radial axis angle of the crankshaft shown at 40 degrees;

FIG. 23B is a schematic partial end section view taken along line B-B of FIG. 20 with the radial axis angle of the crankshaft shown at 40 degrees;

FIG. 24A is a schematic partial end section view taken along line A-A of FIG. 20 with the radial axis angle of the crankshaft shown at 60 degrees;

FIG. 24B is a schematic partial end section view taken along line B-B of FIG. 20 with the radial axis angle of the crankshaft shown at 60 degrees;

FIG. 25A is a schematic partial end section view taken along line A-A of FIG. 20 with the radial axis angle of the crankshaft shown at 120 degrees;

FIG. 25B is a schematic partial end section view taken along line B-B of FIG. 20 with the radial axis angle of the crankshaft shown at 120 degrees;

FIG. 26A is a schematic partial end section view taken along line A-A of FIG. 20 with the radial axis angle of the crankshaft shown at 180 degrees;

FIG. 26B is a schematic partial end section view taken along line B-B of FIG. 20 with the radial axis angle of the crankshaft shown at 180 degrees;

FIG. 27A is a schematic partial end section view taken along line A-A of FIG. 20 with the radial axis angle of the crankshaft shown at 270 degrees;

FIG. 27B is a schematic partial end section view taken along line B-B of FIG. 20 with the radial axis angle of the crankshaft shown at 270 degrees;

FIG. 28A is a schematic partial end section view taken along line A-A of FIG. 20 with the radial axis angle of the crankshaft shown at 0/360 degrees;

FIG. 28B is a schematic partial end section view taken along line B-B of FIG. 20 with the radial axis angle of the crankshaft shown at 0/360 degrees;

FIG. 29A is a schematic perspective view of another exemplary embodiment of a connecting rod;

FIG. 29B is a schematic perspective section view of the exemplary connecting rod shown in FIG. 29A;

FIG. 30A is a schematic partial end section view taken along line A-A of FIG. 20 showing the exemplary connecting rod shown in FIGS. 29A and 29B, with the radial axis angle of the crankshaft shown at 0 degrees;

FIG. 30B is a schematic partial end section view taken along line B-B of FIG. 20 showing the exemplary connecting rod shown in FIGS. 29A and 29B, with the radial axis angle of the crankshaft shown at 0 degrees;

FIG. 31A is a schematic partial end section view taken along line A-A of FIG. 20 showing the exemplary connecting rod shown in FIGS. 29A and 29B, with the radial axis angle of the crankshaft shown at 40 degrees;

FIG. 31B is a schematic partial end section view taken along line B-B of FIG. 20 showing the exemplary connecting rod shown in FIGS. 29A and 29B, with the radial axis angle of the crankshaft shown at 40 degrees;

FIG. 32A is a schematic partial end section view taken along line A-A of FIG. 20 showing the exemplary connecting rod shown in FIGS. 29A and 29B, with the radial axis angle of the crankshaft shown at 60 degrees;

FIG. 32B is a schematic partial end section view taken along line B-B of FIG. 20 showing the exemplary connecting rod shown in FIGS. 29A and 29B, with the radial axis angle of the crankshaft shown at 60 degrees;

FIG. 33A is a schematic partial end section view taken along line A-A of FIG. 20 showing the exemplary connecting rod shown in FIGS. 29A and 29B, with the radial axis angle of the crankshaft shown at 120 degrees;

FIG. 33B is a schematic partial end section view taken along line B-B of FIG. 20 showing the exemplary connecting rod shown in FIGS. 29A and 29B, with the radial axis angle of the crankshaft shown at 120 degrees;

FIG. 34A is a schematic partial end section view taken along line A-A of FIG. 20 showing the exemplary connecting rod shown in FIGS. 29A and 29B, with the radial axis angle of the crankshaft shown at 270 degrees;

FIG. 34B is a schematic partial end section view taken along line B-B of FIG. 20 showing the exemplary connecting rod shown in FIGS. 29A and 29B, with the radial axis angle of the crankshaft shown at 270 degrees;

FIG. 35A is a schematic partial end section view taken along line A-A of FIG. 20 showing the exemplary connecting rod shown in FIGS. 29A and 29B, with the radial axis angle of the crankshaft shown at 0/360 degrees;

FIG. 35B is a schematic partial end section view taken along line B-B of FIG. 20 showing the exemplary connecting rod shown in FIGS. 29A and 29B, with the radial axis angle of the crankshaft shown at 0/360 degrees;

FIG. 36A is a schematic perspective view of another exemplary embodiment of a connecting rod;

FIG. 36B is a schematic perspective section view of the exemplary connecting rod shown in FIG. 36A;

FIG. 37A is a schematic partial end section view taken along line A-A of FIG. 20 showing the exemplary connecting rod shown in FIGS. 36A and 36B, with the radial axis angle of the crankshaft shown at 0 degrees;

FIG. 37B is a schematic partial end section view taken along line B-B of FIG. 20 showing the exemplary connecting rod shown in FIGS. 36A and 36B, with the radial axis angle of the crankshaft shown at 0 degrees;

FIG. 38A is a schematic partial end section view taken along line A-A of FIG. 20 showing the exemplary connecting rod shown in FIGS. 36A and 36B, with the radial axis angle of the crankshaft shown at 40 degrees;

FIG. 38B is a schematic partial end section view taken along line B-B of FIG. 20 showing the exemplary connecting rod shown in FIGS. 36A and 36B, with the radial axis angle of the crankshaft shown at 40 degrees;

FIG. 39A is a schematic partial end section view taken along line A-A of FIG. 20 showing the exemplary connecting rod shown in FIGS. 36A and 36B, with the radial axis angle of the crankshaft shown at 60 degrees;

FIG. 39B is a schematic partial end section view taken along line B-B of FIG. 20 showing the exemplary connecting rod shown in FIGS. 36A and 36B, with the radial axis angle of the crankshaft shown at 60 degrees;

FIG. 40A is a schematic partial end section view taken along line A-A of FIG. 20 showing the exemplary connecting rod shown in FIGS. 36A and 36B, with the radial axis angle of the crankshaft shown at 120 degrees;

FIG. 40B is a schematic partial end section view taken along line B-B of FIG. 20 showing the exemplary connecting rod shown in FIGS. 36A and 36B, with the radial axis angle of the crankshaft shown at 120 degrees;

FIG. 41A is a schematic partial end section view taken along line A-A of FIG. 20 showing the exemplary connecting rod shown in FIGS. 36A and 36B, with the radial axis angle of the crankshaft shown at 270 degrees;

FIG. 41B is a schematic partial end section view taken along line B-B of FIG. 20 showing the exemplary connecting rod shown in FIGS. 36A and 36B, with the radial axis angle of the crankshaft shown at 270 degrees;

FIG. 42A is a schematic partial end section view taken along line A-A of FIG. 20 showing the exemplary connecting rod shown in FIGS. 36A and 36B, with the radial axis angle of the crankshaft shown at 0/360 degrees; and

FIG. 42B is a schematic partial end section view taken along line B-B of FIG. 20 showing the exemplary connecting rod shown in FIGS. 36A and 36B, with the radial axis angle of the crankshaft shown at 0/360 degrees.

### DESCRIPTION OF EXEMPLARY EMBODIMENTS

Reference will now be made in detail to an exemplary embodiments. Wherever possible, the same reference numbers are used in the drawings and the description to refer to the same or like parts.

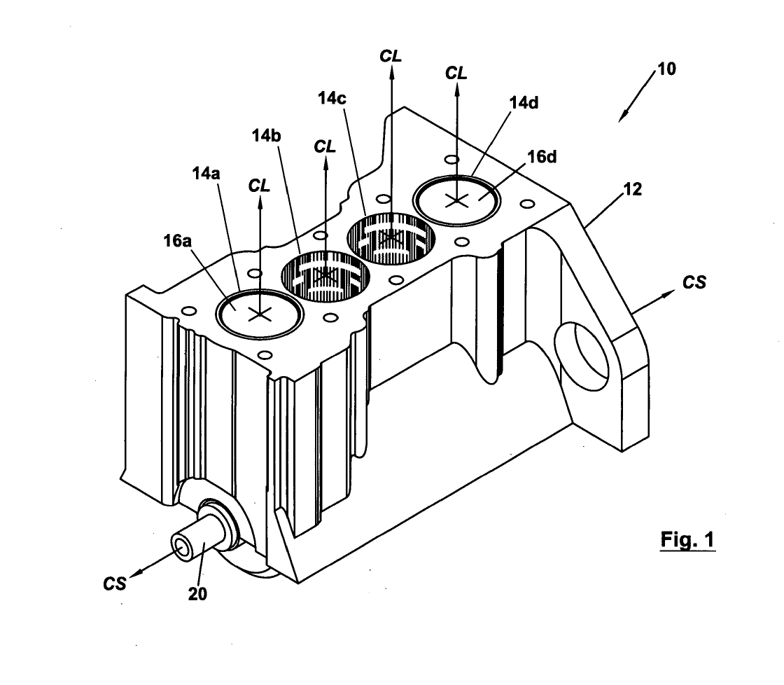

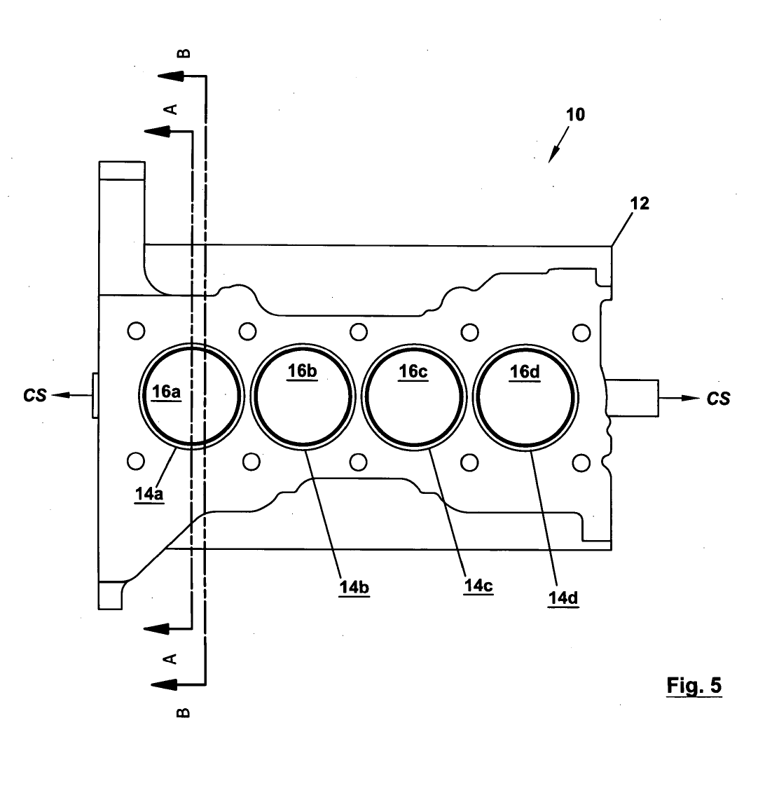

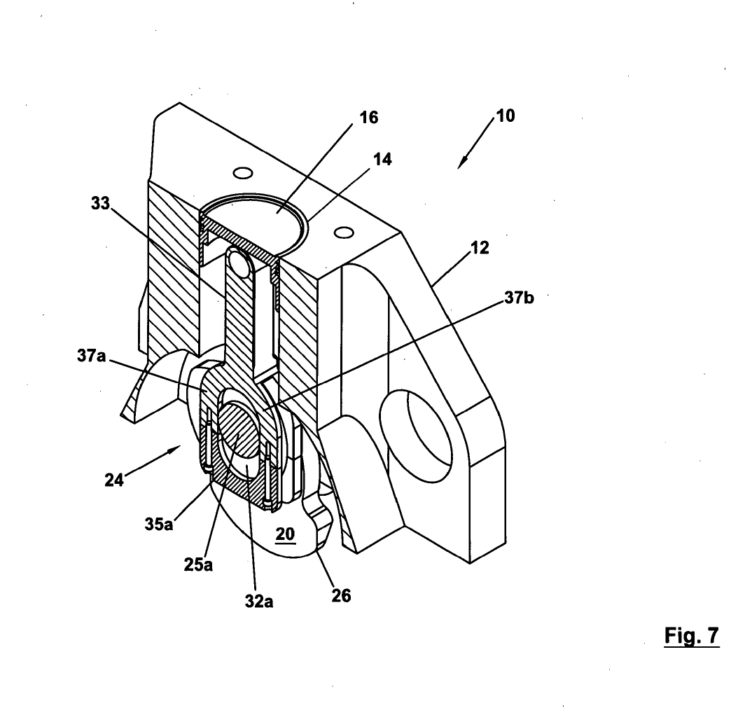

Exemplary engine 10 shown in FIGS. 1-15 is a reciprocating-piston internal combustion engine. As shown in FIG. 1, engine 10 includes a cylinder block 12. Cylinder block 12 defines a number of cylinders 14, each defining a longitudinal axis CL. In the exemplary embodiment shown, engine 10 has an in-line configuration and four cylinders 14a, 14b, 14c, and 14d. Although exemplary engine 10 has a configuration commonly referred to as an “in-line four” configuration, engine 10 may have other configurations known to those skilled in the art, such as, for example, configurations commonly referred to as “V,” “W,” “H,” “flat,” “horizontally-opposed,” and “radial.” Further, although exemplary engine 10 has four cylinders, engine 10 may have other numbers of cylinders known to those skilled in the art, such as, for example, one, two, three, five, six, eight, twelve, sixteen, twenty, and twenty-four. Thus, engine 10 may have, for example, any one of configurations commonly referred to as “flat-four,” “flat-six,” “in-line six,” “V-6,” “straight-eight,” “V-8,” “V-10,” “V-12,” “W-12,” and “H-16.” Further, although exemplary engine 10 is described herein in relation to four-stroke operation, other operations known to those skilled in the art are contemplated, such as, for example, two-stroke, three-stroke, five-stroke, and six-stroke operation. Exemplary engine 10 may be a spark-ignition engine, compression-ignition engine, or combinations and/or modifications thereof known to those skilled in the art.

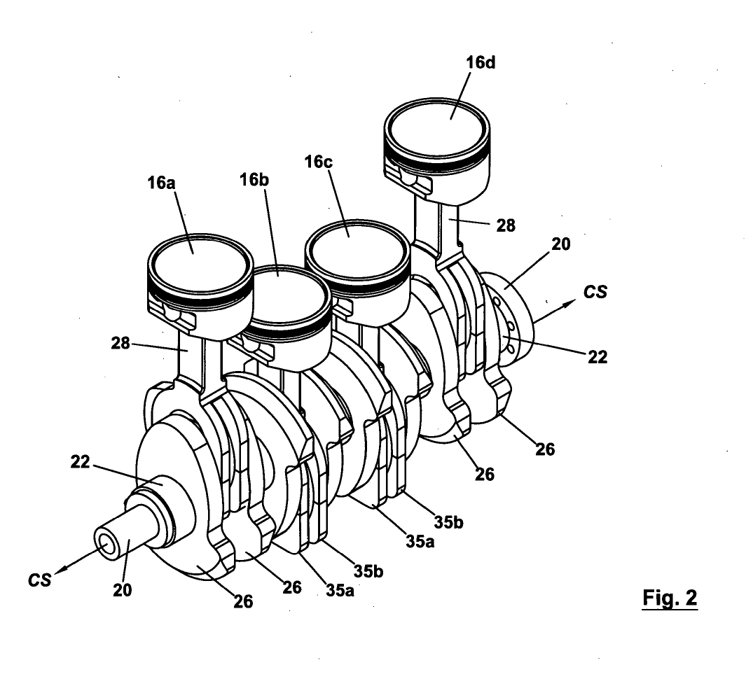

As shown in FIGS. 1 and 2, exemplary engine 10 includes pistons 16 corresponding to cylinders 14, for example, four pistons 16a, 16b, 16c, and 16d. As shown in FIG. 1, pistons 16a and 16d are positioned in the upper end (i.e., “upper” being relative to the orientation of engine 10 shown in FIG. 1) of cylinders 14a and 14d, respectively, while pistons 16b and 16c are not visible in FIG. 1 due to being positioned lower in the cylinders 14b and 14c, respectively. To the extent that the relative positions of the pistons 16 in the cylinders 14 tend to indicate a relative firing order of engine 10 (i.e., the sequential order of combustion events as identified by cylinders), exemplary engine 10 may be configured to have a different firing order, as is known to those skilled in the art.

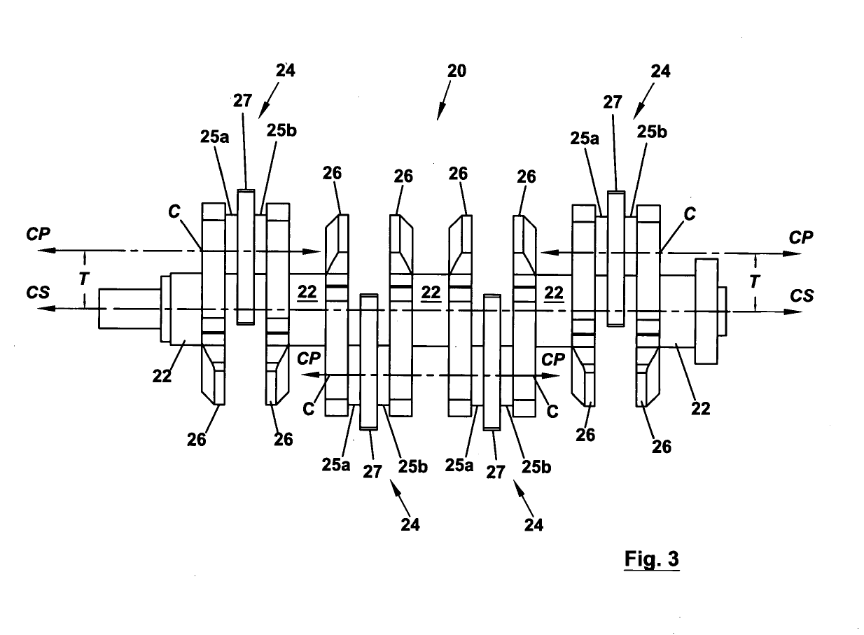

Cylinder block 12 of exemplary engine 10 defines a number of bearings (not shown) for receiving a crankshaft 20, such that crankshaft 20 may rotate relative to cylinder block 12 along a longitudinal crankshaft axis CS defined by crankshaft 20. For example, as shown in FIG. 3, crankshaft 20 defines a number of crankshaft journals 22 having a circular cross-section with a cross-section center. The number of crankshaft journals 22 may correspond to the number of bearings defined by cylinder block 12, and crankshaft journals 22 are received by bearings, such that crankshaft 20 may rotate along longitudinal crankshaft axis CS.

Exemplary crankshaft 20 shown in FIGS. 2 and 3 also defines a number of crankpins 24 corresponding to the number of pistons 16, although the number of crankpins 24 does not necessarily equal the number of pistons 16, for example, if more than one piston 16 is associated with a single crankpin 24. As shown in FIG. 3, each of exemplary crankpins 24 includes a pair of crankpin journals 25a and 25b separated by a crankpin cam 27, although according to some embodiments each crankpin 24 may include a single crankpin journal and a single crankpin cam. According to some embodiments, a crankpin 24 may include more than two crankpin journals and more than one crankpin cam, for example, if more than one piston 16 is associated with each crankpin 24.

Exemplary crankpin journals 25a and 25b are circular in cross section, and the respective circular cross-sections may define a center C, which, in turn, defines a longitudinal crankpin axis CP extending in a perpendicular manner through center C of the cross-section of the respective crankpin journals 25a and 25b, such that crankpin axis CP is parallel and offset with respect to crankshaft axis CS. For example, crankpin axis CP is spaced a distance T from the longitudinal axis CS of crankshaft 20. Crankshaft 20 may also include a number of counterbalance weights 26 for providing (or improving) rotational balance of crankshaft 20 when assembled with pistons 16 and connecting rods.

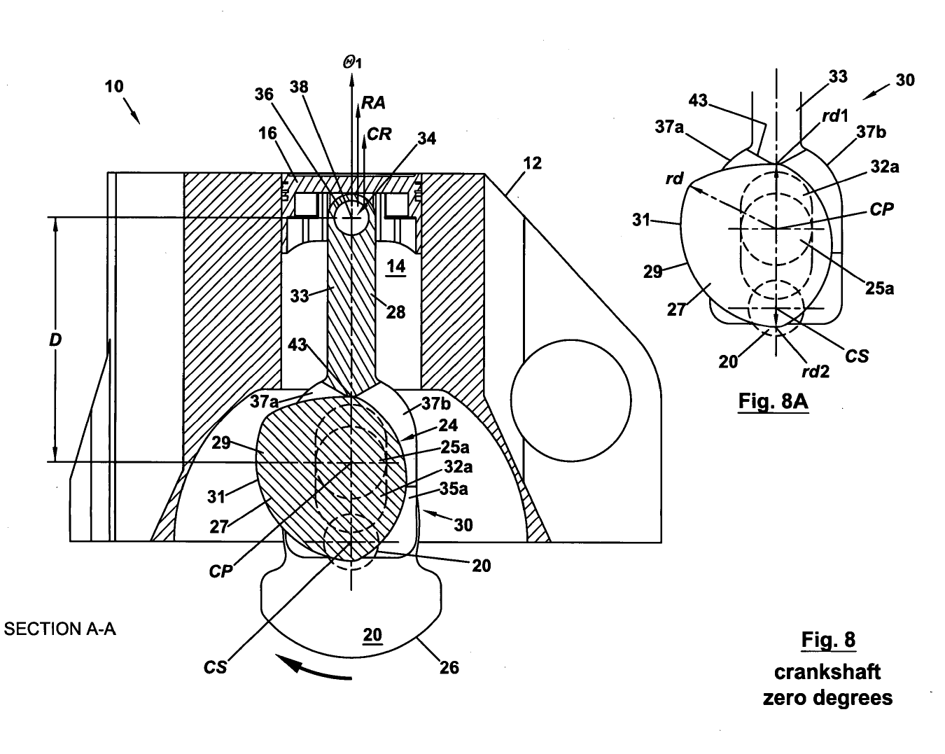

Regarding exemplary crankpin cam 27, as shown in, for example, FIGS. 8 and 8A, crankpin cam 27 defines a cam profile 29 corresponding to a radial distance r_{d} from crankpin axis CP to the edge face 31 of cam 27. Radial distance r_{d} varies from a minimum radial distance to a maximum radial distance to define cam profile 29. As shown in FIG. 8A, in a first direction d₁ extending along a line from the longitudinal crankshaft axis CS toward the longitudinal crankpin axis CP, the radial distance r_{d1} associated with the first direction d₁ is less than the maximum radial distance. Also, in a second direction d₂ extending along a line from the longitudinal crankpin axis CP toward the longitudinal crankshaft axis CS, the radial distance r_{d2} associated with the second direction d₂ is greater than the radial distance r_{d1} associated with the first direction d₁.

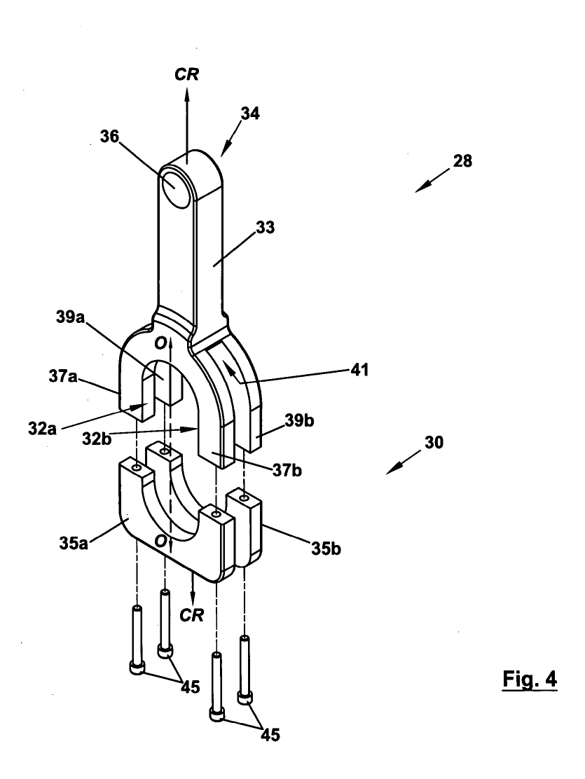

Referring to FIG. 2, for example, pistons 16 are operably coupled to crankpins 24 via a number of respective connecting rods 28 corresponding to the number of pistons 16. For example, exemplary connecting rods 28 (see, e.g., FIG. 4) include a proximal end 30 having an oblong opening 32 and a distal end 34 having a second aperture 36. Proximal end 30 of exemplary connecting rod 28 is operably coupled to crankpin 24 of crankshaft 20 via oblong openings 32a and 32b, and distal end 34 of connecting rod 28 is operably coupled to piston 16 via a pin 38.

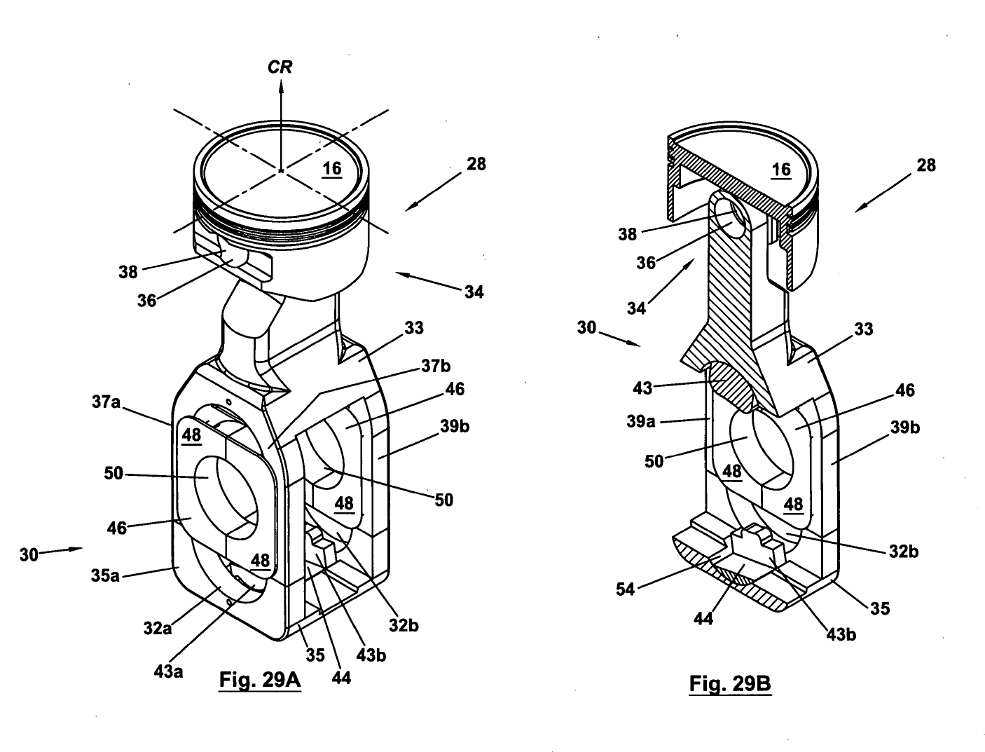

As shown in FIG. 4, exemplary connecting rod 28 includes a rod portion 33 and two cap portions 35a and 35b, although some embodiments may only include a single cap portion (see, e.g., FIG. 29A). Exemplary rod portion 33 and exemplary cap portions 35a and 35b define oblong openings 32a and 32b, with oblong openings 32a and 32b each defining a longitudinal axis O, which may generally extend parallel to a longitudinal axis CR of connecting rod 28. Oblong openings 32a and 32b define a width orthogonal to longitudinal axes O that generally corresponds to the cross-sectional diameter of crankpin journals 25a and 25b, thereby permitting crankpin journals 25a and 25b to move linearly relative to connecting rod 28. This exemplary configuration permits relative linear movement between the longitudinal crankpin axis CP and proximal end 30 of connecting rod 28.

As shown in FIG. 4, exemplary rod portion 33 includes a first pair of legs 37a and 37b and a second pair of legs 39a and 39b spaced from the first pair of legs 37a and 37b, thereby providing a clearance 41 between the first and second pairs of legs. First pair of legs 37a and 37b at least partially defines first oblong opening 32a, and second pair of legs 39a and 39b at least partially defines second oblong opening 32b.

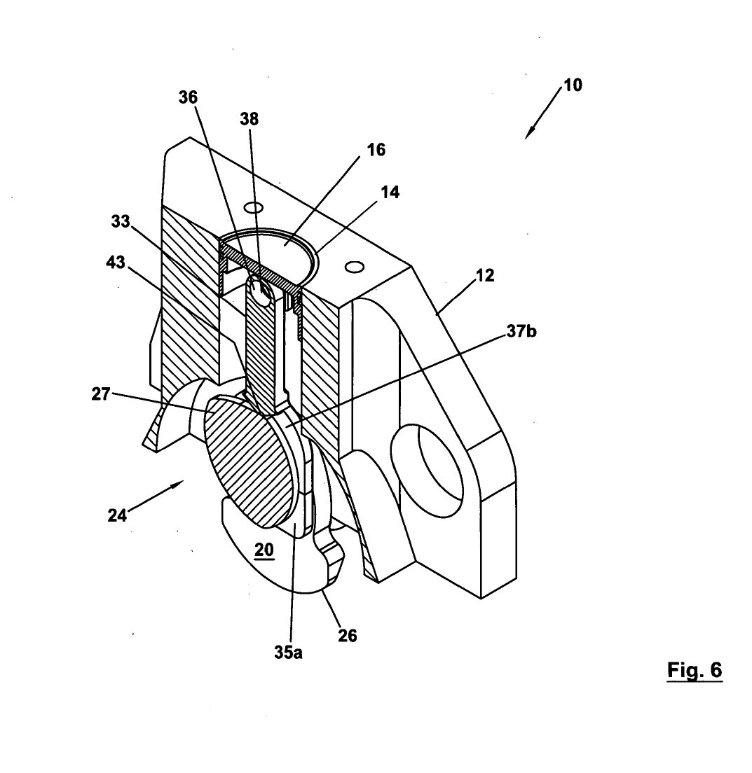

As shown in FIG. 6, rod portion 33 includes a follower 43 associated with clearance 41. For example, in the exemplary embodiment shown, follower 43 is located in clearance 41 at the apex of first pair of legs 37a and 37b and second pair of legs 39a and 39b. (FIGS. 6-15 are schematic section views, and thus, they may not show some of the subject matter identified in the descriptions of those figures, such as, for example, second pair of legs 39a and 39b, crankpin journal 25b, and oblong opening 32b). Rod portion 33 of connecting rod 28 is coupled to crankshaft 20 such that first pair of legs 37a and 37b is associated with first crankpin journal 25a and second crankpin journal 25b, respectively, with cam 27 of crankpin 24 being positioned in clearance 41 (see FIGS. 3, 6, and 7). As shown in FIG. 4, exemplary cap portions 35a and 35b are coupled to first pair of legs 37a and 37b and second pair of legs 39a and 39b, respectively, by cap bolts 45, thereby enclosing respective oblong openings 32a and 32b about respective crankpin journals 25a and 25b, with cam 27 confined in clearance 41 of connecting rod 28.

With exemplary crankpin 24 and connecting rod 28 coupled to one another in this exemplary manner, cam profile 29 of crankpin 24's cam 27 interacts with follower 43 of connecting rod 28, such that as crankshaft 20 rotates, crankpin 24 rotates relative to connecting rod 28. Follower 43 rides on cam 27 and as the radial distance r_{d} of cam profile 29 varies, proximal end 30 of connecting rod 28 moves linearly with respect to longitudinal crankpin axis CP by virtue of crankpin journals 25a and 25b reciprocating along the longitudinal axis O within oblong openings 32a and 32b, as explained in more detail with respect to FIGS. 8-15. As a result of this exemplary configuration, the stroke of exemplary engine 10 is affected according to interaction between cam 27 and follower 43. As explained in more detail herein, this exemplary configuration may permit tailoring of the operation characteristics (e.g., power output, torque, efficiency, and/or responsiveness) of exemplary engine 10.

According to the exemplary embodiment shown in FIGS. 1-15, interaction between crankpin 24 and connecting rod 28 may be configured such that substantial movement of piston 16 toward crankshaft 20 during the power stroke is delayed until crankshaft 20 has rotated to a point at which there is a more effective moment arm between the transmission of the combustion force on piston 16 and a radial axis RA extending between crankshaft axis CS and a respective crankpin axis CP. For example, cam profile 29 of cam 27 may be shaped such that crankpin 24 moves within oblong openings 32a and 32b as crankshaft 20 rotates without any, or any significant amount of, movement of distal end 34 of connecting rod 28, thereby effectively increasing the distance between the center C of crankpin 24 and distal end 34 of connecting rod 28. As a result, a greater amount of the energy of the combustion event may be captured because the maximum force acting on piston 16 coincides with a greater moment arm, thereby resulting in more torque at crankshaft 20 during the power stroke. Timing of initiation of combustion may be tailored to take advantage of the delayed stroke.

During operation of exemplary engine 10, as crankshaft 20 rotates, crankpins 24 revolve around crankshaft longitudinal axis CS, such that crankpin centers C define a circular path having a radius defined by the distance T defined along a radial axis RA (see FIGS. 8-15) extending between the longitudinal axis CS of crankshaft 20 and the longitudinal axis CP of the respective crankpins 24. Thus, proximal ends 30 of connecting rods 28, which are coupled to crankpins 24 via oblong openings 32a and 32b of connecting rods 28, move based on cam profile 29 of cam 27, as explained in more detail below with respect to FIGS. 8-15. Distal ends 34 of connecting rods 28 are constrained to move in a reciprocating and linear manner due to being operably coupled to pistons 16, which are likewise constrained to move in a reciprocating and linear manner within respective cylinders 14 defined by cylinder block 12. As a result, as crankshaft 20 rotates, pistons 16 reciprocate within respective cylinders 14, defining a piston stroke generally corresponding to twice the distance T between the crankpin axis CP and the crankshaft axis CS (as affected according to the exemplary operation described herein).

During operation of a conventional engine, a piston reciprocates within the cylinder, such that during a power stroke of the internal combustion engine, combustion of an air/fuel mixture within a combustion chamber defined by the piston, cylinder, and a cylinder-head forces the piston toward the crankshaft. As the piston travels toward the crankshaft, the crankshaft is rotated via the connecting rod and crankpin, thereby converting the potential energy associated with the compressed air/fuel mixture into mechanical work.

Due to the architecture of a conventional internal combustion engine, however, when the piston is at a position within the cylinder that coincides with the maximum compression (i.e., the combustion chamber is at its lowest volume, this condition generally coinciding with maximum compression, when the piston is farthest from the crankshaft), the radial axis extending between the center of the crankshaft and the center of the crankpin tends to be nearly co-linear, if not co-linear, with the axis of the connecting rod. At these relative positions, as the piston first begins its movement toward the crankshaft during the power stroke, there is only a very short moment arm (if any) extending between the axis of the connecting rod and the radial axis. As a result, the force initially created by the air/fuel mixture at the moment of combustion does not transfer as much torque to the crankshaft as it would if the length of the moment arm were greater. This situation may be particularly undesirable because, during combustion and very shortly thereafter, the force on the piston due to the combustion event may approach its maximum magnitude. Further, as the piston travels down the cylinder toward the crankshaft and the length of the moment arm increases, the magnitude of the force from the combustion event acting on the piston may dissipate rapidly. Thus, because there is a very short moment arm created between the axis of the connecting rod and the radial axis during the time of maximum force on the piston, efficiency of the work generated from the combustion process in a conventional internal combustion engine may be less than desired.

Exemplary engine 10 may be configured to selectively employ a strategy that delays substantial movement of piston 16 toward crankshaft 20 during the power stroke, until crankshaft 20 has rotated to a point at which there is a more effective moment arm between the combustion force on piston 16 and radial axis RA extending between crankshaft axis CS and a respective crankpin axis CP. As a result, a greater amount of the energy of the combustion event may be captured because the maximum force acting on piston 16 coincides with a greater moment arm, thereby resulting in more torque at crankshaft 20 during the power stroke. Timing of the initiation of combustion may be tailored to take advantage of the delayed stroke.

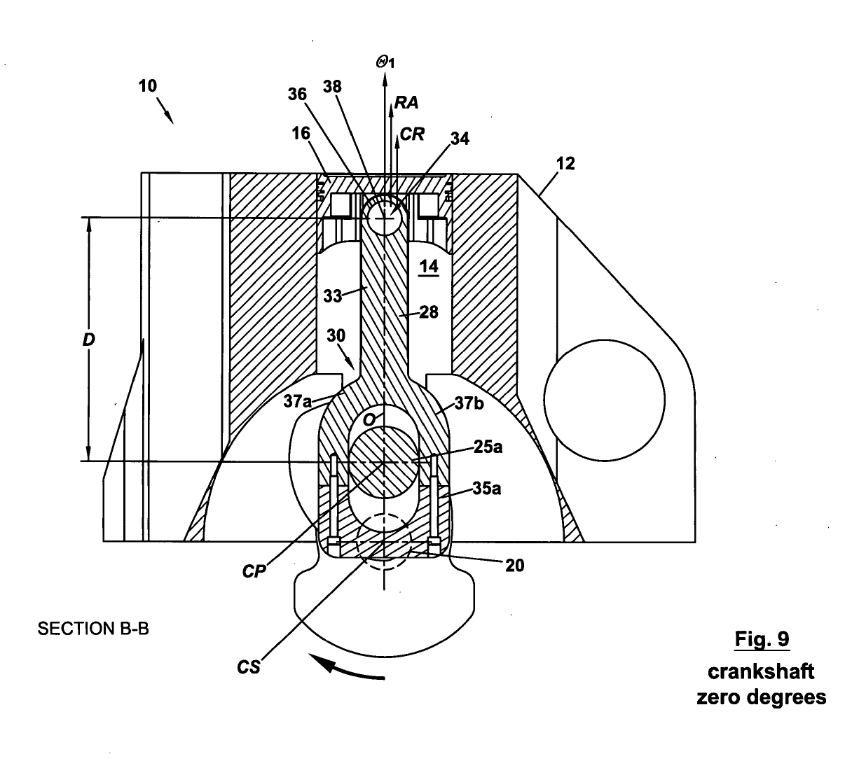

FIGS. 8-15 schematically illustrate exemplary operation of engine 10 having exemplary crankshaft 20 and connecting rod 28, which may serve to delay piston 16's travel at the beginning of the power stroke of engine 10. For example, follower 43 of connecting rod 28 interacts with cam profile 29 of crankpin 24, resulting in crankpin journals 25a and 25b reciprocating within oblong openings 32a and 32b, thereby altering the effective length of connecting rod 28. As shown in FIGS. 8 and 9, cam profile 29 has a radial distance r_{d} from longitudinal crankpin axis CP that increases, such that crankpin 24 moves within oblong openings 32a and 32b as crankshaft 20 rotates, without substantially moving distal end 34 of connecting rod 28, thereby effectively increasing the distance D between the center C of crankpin 24 and distal end 34 of connecting rod 28. Such an exemplary embodiment renders it possible to effectively hold piston 16 in cylinder 14 at a substantially fixed position for a short period of time, even as crankpin 24 continues to revolve around crankshaft 20's axis CS as crankshaft 20 rotates. As a result, it is possible to hold piston 16 at the point of highest compression in the combustion chamber while crankpin 24 revolves to a position, which results in an increased moment arm defined by the transmission of the force acting on piston 16 and the radial axis RA extending between the center of crankshaft 20 and the center C of crankpin 24. This results in relatively more torque being applied to crankshaft 20 as combustion begins, with piston 16 still remaining at a point farthest from the center of crankshaft 20 (i.e., at the end of its upward stroke as shown). In this exemplary manner, the delaying strategy outlined below may be implemented.

For example, as shown in FIGS. 8 and 9, crankshaft 20 is oriented such that radial axis RA defined by the center of crankshaft 20 and the center C of crankpin 24 is oriented at zero degrees, which corresponds generally to a first stroke termination angle θ₁ that generally coincides with the end of the compression stroke (and the exhaust stroke in a four-stroke engine) of exemplary engine 10. Thus, with radial axis RA in this orientation, piston 16 is at its upper position within cylinder 14.

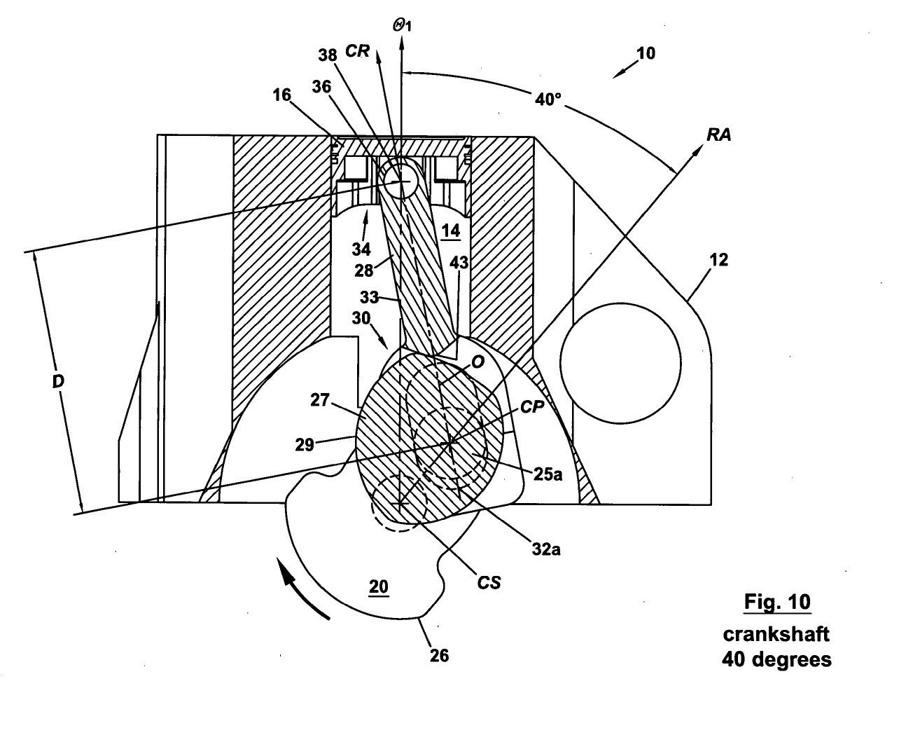

As shown in FIG. 8, during operation of engine 10, crankshaft 20 rotates in the clockwise direction. With cam profile 29 and follower 43 interacting as shown, crankpin journals 25a and 25b are located generally centrally within the length of oblong openings 32a and 32b (see FIG. 9), such that piston 16 is at the top of its stroke while the radial axis RA of crankshaft 20 is substantially aligned with the longitudinal axis CR of connecting rod 28. This position and exemplary configuration results in the distance D between the center C of crankpin 24 and distal end 34 (e.g., the center of second aperture 36) of connecting rod 28 being reduced relative to the distance D shown in FIGS. 10-13.

FIG. 10 shows crankshaft 20 in an orientation where radial axis RA has rotated 40 degrees past first stroke termination angle θ₁. In a conventional engine, piston 16 would have traveled a significant distance toward crankshaft axis CS as radial axis RA rotated through 40 degrees. In contrast, according to exemplary engine 10, piston 16 has not yet started its downward travel toward crankshaft axis CS. Instead, cam 27 has rotated relative to oblong openings 32a and 32b, such that interaction between cam profile 29 and follower 43 results in crankpin journals 25a and 25b moving down (in the orientation shown) within oblong openings 32a and 32b to a position more remote from the central portion of oblong openings 32a and 32b, in a manner resulting in no substantial movement of proximal end 30 or distal end 34 of connecting rod 28. In particular, radial distance r_{d} of cam profile 29 has increased, thereby forcing crankpin journals 25a and 25b down oblong openings 32a and 32b. As a result, the distance D between the center C of crankpin 24 and distal end 34 of connecting rod 28 has increased relative to the distance D shown in FIGS. 8 and 9. As a result of this increase in the distance D, piston 16 has not traveled a substantial distance down cylinder 14, even though crankpin 24 has rotated clockwise relative to the center C of crankshaft 20, such that the center C of crankpin 24 is farther from the top of cylinder 14. (See Table 1 below showing an exemplary relationship for exemplary engine 10 between radial axis RA's angle and piston 16's displacement relative to the first stroke termination angle θ₁.) As a result, the distance D increases, such that rather than beginning downward travel in cylinder 14, piston 16 remains substantially in its position of maximum stroke.

TABLE 1
RADIAL AXIS RA ANGLE VS. PISTON DISPLACEMENT
RELATIVE TO ZERO DEGREES FOR FIGS. 8-15

| Crank Angle | Piston Depth |
|---|---|
| 0 | 0.000 |
| 4 | 0.000 |
| 8 | 0.000 |
| 12 | 0.000 |
| 16 | 0.000 |
| 20 | 0.000 |
| 24 | 0.000 |
| 28 | 0.000 |
| 32 | 0.000 |
| 36 | 0.000 |
| 40 | 0.000 |
| 44 | 0.001 |
| 48 | 0.044 |
| 52 | 0.136 |
| 56 | 0.270 |
| 60 | 0.413 |
| 64 | 0.559 |
| 68 | 0.706 |
| 72 | 0.854 |
| 76 | 1.001 |
| 80 | 1.148 |
| 84 | 1.293 |
| 88 | 1.453 |
| 92 | 1.574 |
| 96 | 1.709 |
| 100 | 1.840 |
| 104 | 1.965 |
| 108 | 2.086 |
| 112 | 2.200 |
| 116 | 2.308 |
| 120 | 2.308 |
| 124 | 2.505 |
| 128 | 2.594 |
| 132 | 2.675 |
| 136 | 2.750 |
| 140 | 2.818 |
| 144 | 2.878 |
| 148 | 2.932 |
| 152 | 2.979 |
| 156 | 3.081 |
| 160 | 3.051 |
| 164 | 3.076 |
| 168 | 3.094 |
| 172 | 3.106 |
| 176 | 3.110 |
| 180 | 3.110 |

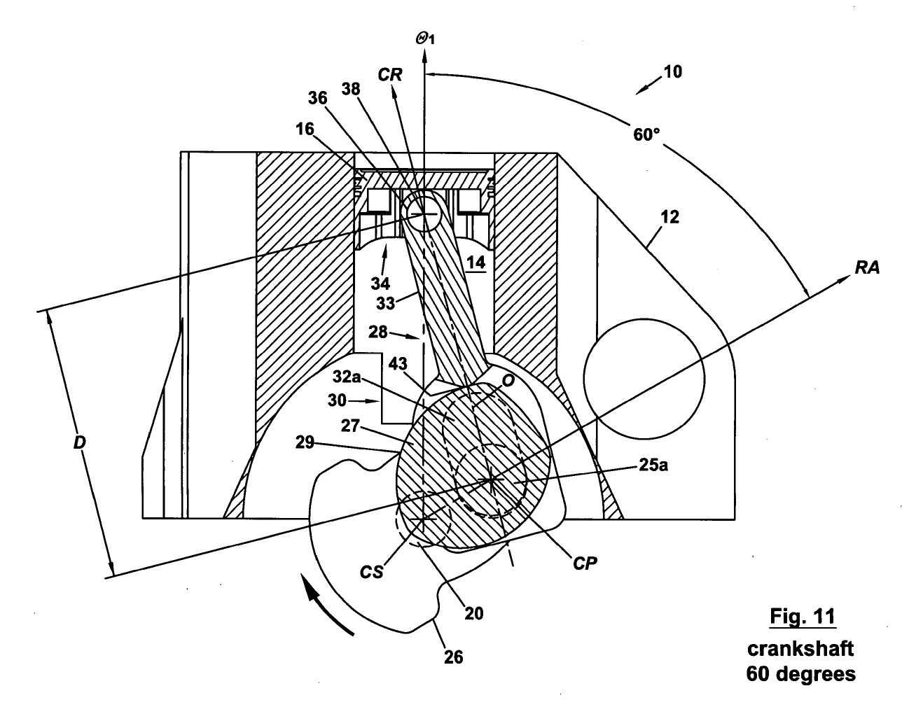

Referring to FIG. 11, when the radial axis RA has rotated to 60 degrees past the first stroke termination angle θ₁, combustion has commenced, thereby driving piston 16 partially down cylinder 14. Cam 27 has rotated relative to oblong openings 32a and 32b, such that interaction between cam profile 29 and follower 43 results in crankpin journals 25a and 25b moving to the end of oblong openings 32a and 32b remote from rod portion 33 of connecting rod 28. Radial distance r_{d} of cam profile 29 has continued to increase, resulting in crankpin journals 25a and 25b being forced farther down oblong openings 32a and 32b. As a result, the distance D between the center C of crankpin 24 and distal end 34 of connecting rod 28 has increased slightly relative the distance D shown in FIG. 10. Thus, between 40 and 60 degrees past the first stroke termination angle θ₁, crankpin journals 25a and 25b have almost reached the end of oblong openings 32a and 32b. At this radial position, follower 43 of rod portion acts against cam 27, and piston 16 begins to travel down cylinder 14 toward longitudinal crankshaft axis CR. In particular, in the example shown, piston 16 has traveled 0.413 inch down cylinder 14 as radial axis RA has rotated from 40 to 60 degrees past stroke termination angle θ₁.

At this position of radial axis RA, radial axis RA is no longer aligned with the longitudinal axis CR of connecting rod 28. As combustion force on piston 16 pushes down on cam 27, and causes force on piston 16 to be directed to crankpin 24. This exemplary arrangement results in an increased moment arm for driving crankshaft 20 in the clockwise direction (as shown). As compared to an engine having a conventional architecture, this results in relatively more torque being applied to crankshaft 20 as combustion begins between 40 and 60 degrees past first stroke termination angle θ₁. As a result of crankpin journals 25a and 25b moving to the end of oblong openings 32a and 32b remote from distal end 34 of connecting rod 28, the distance D between the center C of crankpin 24 and distal end 34 of connecting rod 28 has continued to increase relative to the distance D shown in FIG. 10.

Although the exemplary embodiment shown in FIGS. 8-15 shows the point at which piston 16 begins to move from its point of maximum stroke to be where radial axis RA has rotated 40 degrees past first stroke termination angle θ₁, this point may be between 40 and 60 degrees past first stroke termination angle θ₁ (e.g., 59 degrees, 55 degrees, 50 degrees, 45 degrees, or 41 degrees). According to some embodiments, the radial position of crankshaft 20 at which the piston 16 begins to move from its point of maximum stroke may be adjusted during operation according to predetermined criteria in order to tailor operation of engine 10, as explained in more detail herein.

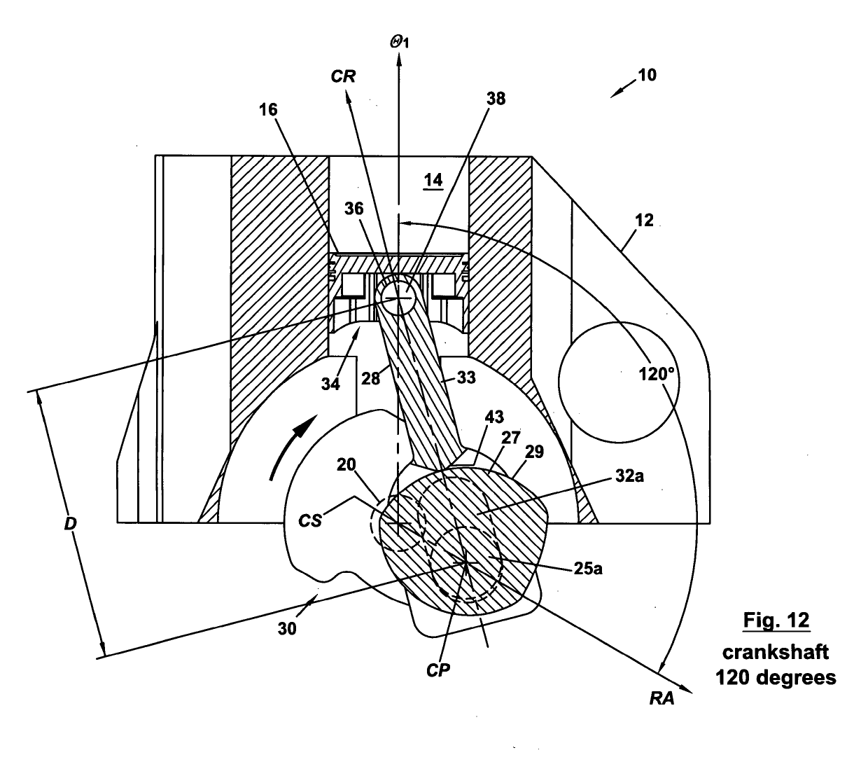

Referring to FIG. 12, radial axis RA has rotated 120 degrees past first stroke termination angle θ₁. As shown, cam profile 29 and follower 43 interact such that crankpin journals 25a and 25b remain in substantially the same position in oblong openings 32a and 32b, as shown in FIG. 11. Radial distance r_{d} of cam profile 29 has remained substantially the same, resulting in crankpin journals 25a and 25b remaining at substantially the same position within oblong openings 32a and 32b. As a result, the distance D between the center C of crankpin 24 and distal end 34 of connecting rod 28 has remained substantially the same relative to the distance D shown in FIG. 11. As a result, piston 16 has traveled farther down cylinder 14. In the example shown, piston 16 has traveled 2.308 inches from its position at stroke termination angle θ₁. Because crankpin journals 25a and 25b have remained in substantially the same position in oblong openings 32a and 32b as shown in FIG. 11, the distance D between the center C of crankpin 24 and distal end 34 of connecting rod 28 has not significantly changed relative to the distance D shown in FIG. 11.

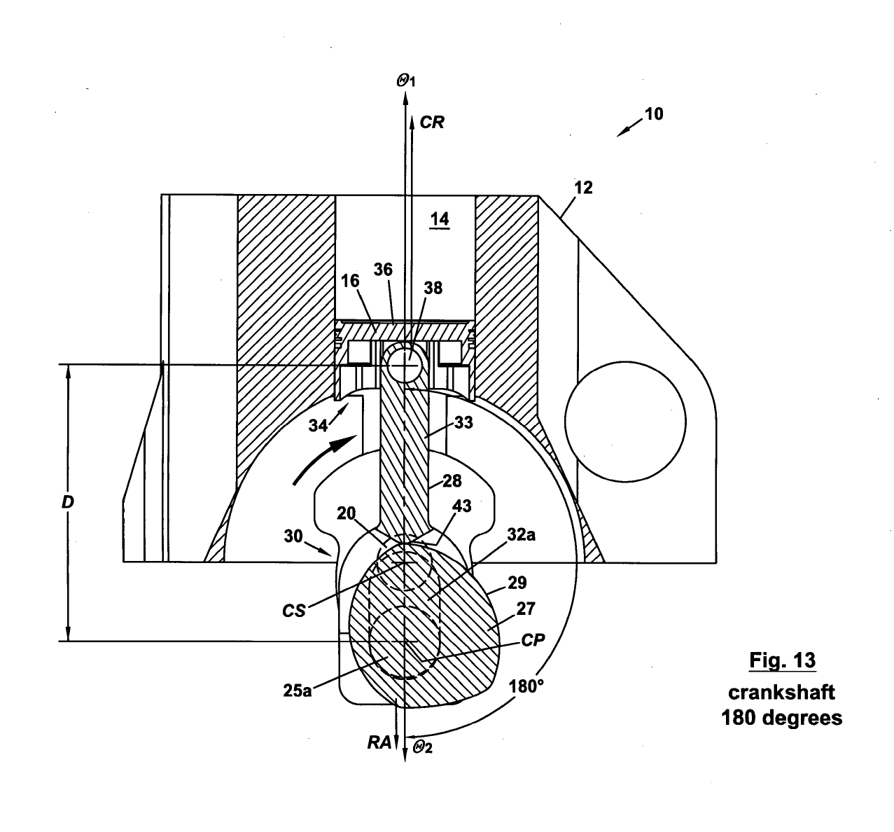

As shown in FIG. 13, radial axis RA has rotated to 180 degrees past the first stroke termination angle θ₁ (i.e., at a second stroke termination angle θ₂, which corresponds generally to the end of the power stroke). Cam profile 29 and follower 43 interact, such that crankpin journals 25a and 25b have reached the end of exemplary oblong openings 32a and 32b. Radial distance r_{d} of cam profile 29 has increased further still, resulting in crankpin journals 25a and 25b being forced farther down oblong openings 32a and 32b. As a result, the distance D between the center C of crankpin 24 and distal end 34 of connecting rod 28 has increased slightly relative to the distance D shown in FIG. 12. As a result, piston 16 has traveled farther down cylinder 14 to a point 3.110 inches from its position at stroke termination angle θ₁.

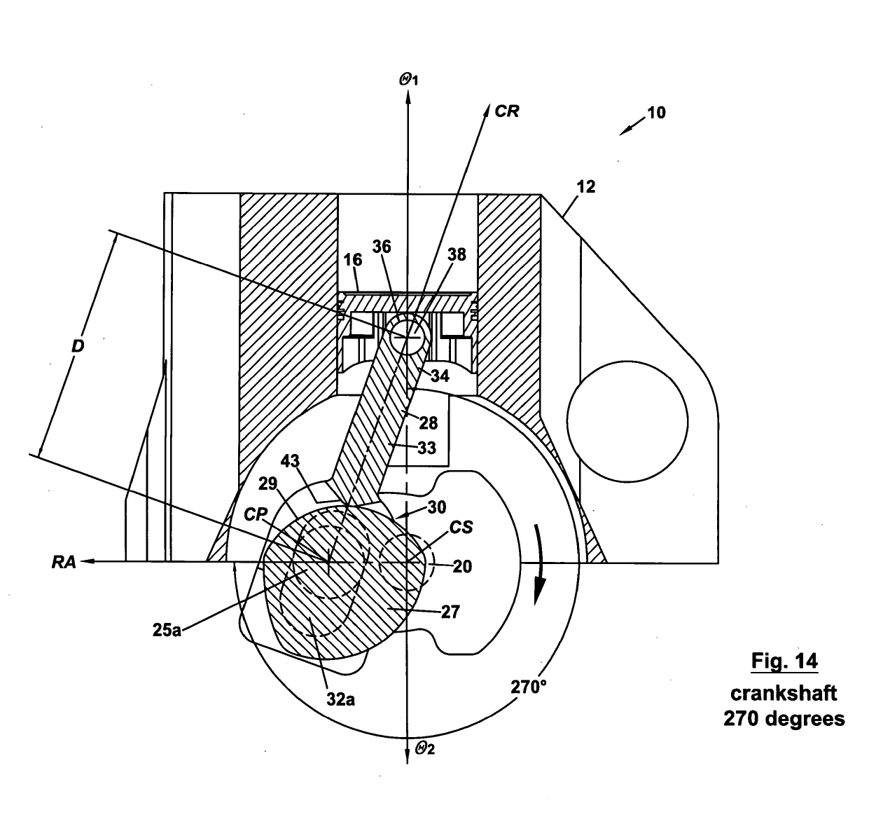

Referring to FIG. 14, radial axis RA has rotated to 270 degrees past the first stroke termination angle θ₁ (i.e., 90 degrees past second stroke termination angle θ₂). Cam profile 29 and follower 43 interact, such that crankpin journals 25a and 25b have returned to a more generally central position within oblong openings 32a and 32b. In particular, radial distance r_{d} of cam profile 29 has decreased significantly relative to FIG. 13, resulting in crankpin journals 25a and 25b being forced back to generally the central portion of oblong openings 32a and 32b. As a result, the distance D between the center C of crankpin 24 and distal end 34 of connecting rod 28 has decreased relative to the distance D shown in FIG. 13. Even though the distance D has shortened, piston 16 has reversed its direction of travel within cylinder 14 and started moving away from longitudinal crankshaft axis CR.

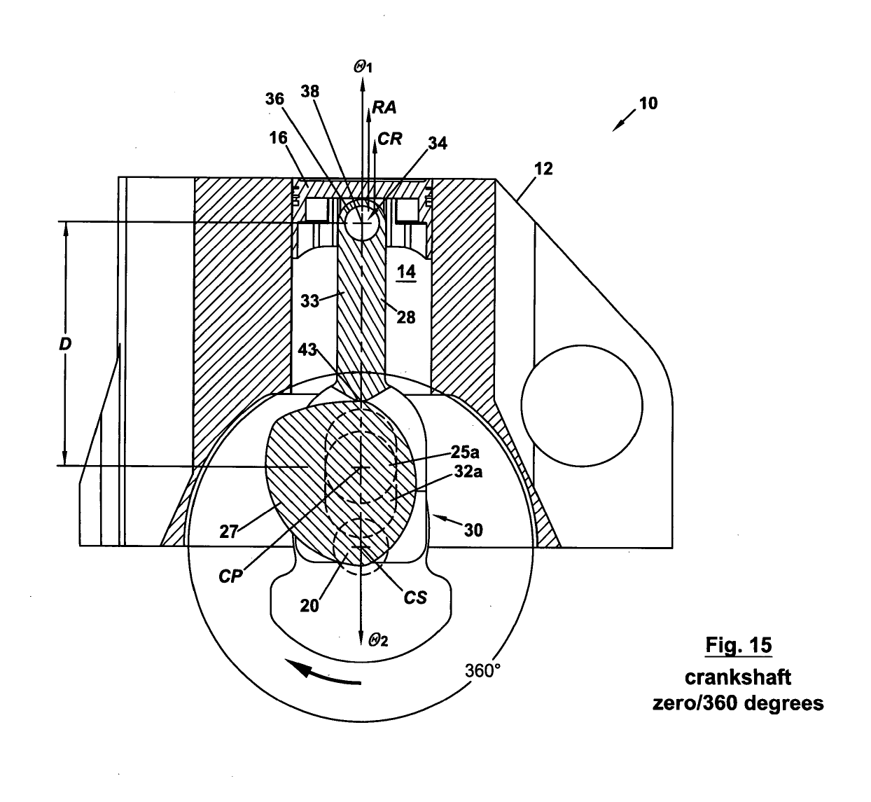

Referring to FIG. 15, radial axis RA has rotated to 360 degrees past the first stroke termination angle θ₁, and thus, has returned to the first stroke termination angle θ₁ shown in FIGS. 8 and 9. As shown in FIG. 15, cam profile 29 and follower 43 have interacted such that crankpin journals 25a and 25b remain in substantially the same position in oblong openings 32a and 32b, as shown in FIG. 14. As a result, radial distance r_{d} of cam profile 29 has remained substantially the same, resulting in crankpin journals 25a and 25b remaining at substantially the same position within oblong openings 32a and 32b. As a result, the distance D between the center C of crankpin 24 and distal end 34 of connecting rod 28 has remained substantially the same relative to the distance D shown in FIG. 14. However, relative to FIG. 13, distance D between the center C of crankpin 24 and distal end 34 of connecting rod 28 has decreased and has partially offset the movement of crankpin 24 toward piston 16 as radial axis RA has rotated from 180 degrees to 360 degrees past the first stroke termination angle θ₁.

In the exemplary manner described above, the distance D between the center C of crankpin 24 and distal end 34 of connecting rod 28 is variable, such that the distance D between the center C of crankpin 24 and distal end 34 of connecting rod 28 (e.g., the center of pin 38) is variable. More specifically, the distance D is variable (see, e.g., FIGS. 8-15), the variability of the distance D being facilitated in the exemplary embodiment by virtue of crankpin 24 and connecting rod 28. As radial axis RA rotates between first stroke termination angle θ₁ and 180 degrees past first stroke termination angle θ₁ (i.e., to second stroke termination angle θ₂), the distance D initially increases, thereby delaying initiation of the power stroke until radial axis RA reaches a point, for example, at least 40 degrees past first stroke termination angle θ₁ in the exemplary embodiment shown. Timing of the initiation of combustion may be tailored to take advantage of this delay. The distance D may remain relatively constant as radial axis RA continues to rotate toward an orientation 180 degrees past first stroke termination angle θ₁ (FIGS. 8-13). As the radial axis RA rotates between 180 and 360 degrees past first stroke termination angle θ₁, the distance D is decreases (FIGS. 13-15).

According to some embodiments, the exemplary configuration and/or interaction between crankshaft 20 and connecting rod 28 may be tailored to achieve desired performance characteristics of exemplary engine 10, such as, for example, improved efficiency, improved torque, improved power output, and/or improved responsiveness. For example, profile 29 of crankpin cam 27 may be configured to improve efficiency and/or power of exemplary engine 10, for example, by changing at least one of the timing and magnitude of the delay of initiation of the power stroke.

According to some embodiments, initiation of the power stroke of exemplary engine 10 may be delayed until radial axis RA has rotated at least about 15 degrees beyond the first stroke termination angle θ₁. In other embodiments, initiation of the power stroke may be delayed until radial axis RA has rotated at least about 30 degrees beyond the first stroke termination angle θ₁ (e.g., at least about 40 or 45 degrees beyond the first stroke termination angle θ₁). In other embodiments, rotation may be set to about 25 or 35 degrees beyond the first stroke termination angle θ₁, for example, to achieve a desired performance characteristic of engine 10.

According to some embodiments, depending on, for example, profile 29 of crankpin cam 27, piston 16 may continue to travel slightly up into cylinder 14 as radial axis RA rotates between 0 degrees and, for example, 40 degrees past first stroke termination angle θ₁, with the downward travel of piston 16 within cylinder 14 beginning thereafter at the end of the delay of the power stroke. In other words, during the delay of the power stroke, piston 16 is not necessarily stationary in cylinder 14, but rather, piston 16 may continue its upward travel in cylinder 14 relative to its position in cylinder 14 as radial axis RA passes 0 degrees relative to first stroke termination angle θ₁.

According to some embodiments, engine 10 may be configured to selectively operate in at least two modes. For example, in a first mode of operation the distance D between the between the center C of crankpin 24 (e.g., the longitudinal axis CP of crankpin 24) and distal end 34 of connecting rod 28 may vary in a constant manner as described above. In a second mode of operation, the relationship between profile 29 of cam 27 and crankpin 24 may be variable in a radial manner, such that the delay in the power stroke of piston 16 may be varied according to a desired tailoring. This may be accomplished via, for example, cam phasing, where cam 27 may rotate relative to crankpin journals 25a and 25b, thereby changing the position of radial axis RA at which the power stroke begins. In this exemplary second mode of operation, it may be possible to tailor operation of engine 10 to vary the power output, torque, and/or efficiency of the operation of engine 10 according to operating parameters. According to some embodiments, engine 10 may operate according to a combination of the first and second modes.

Exemplary engine 10, may be incorporated into a power train, for example, including a transmission operably coupled to engine 10 and a drive member configured to perform work, the drive member being operably coupled to the transmission. For example, the drive member may include a propulsion device, such as, for example, a wheel or a propeller. According to some embodiments, such a power train may include a generator configured to convert rotational power into electrical power, the generator being operably coupled to exemplary engine 10. Such a power train may include a power storage device (e.g., a flywheel and/or one or more batteries) operably coupled to the generator and configured to store electrical power. According to some embodiments, the transmission may include one or more electric motors.

Moreover, exemplary engine 10 may be incorporated into a vehicle including a transmission operably coupled to engine 10 and a drive member configured to perform work and being operably coupled to the transmission. For example, the drive member may include a propulsion device, such as, for example, a wheel or a propeller. For example, the vehicle may be a car, van, truck, boat, ship, train, or air vehicle. Such a vehicle may include exemplary engine 10 operably coupled to a generator configured to convert rotational power into electrical power, and a power storage device operably coupled to the generator and configured to store electrical power. The transmission may be, for example, an electric motor.

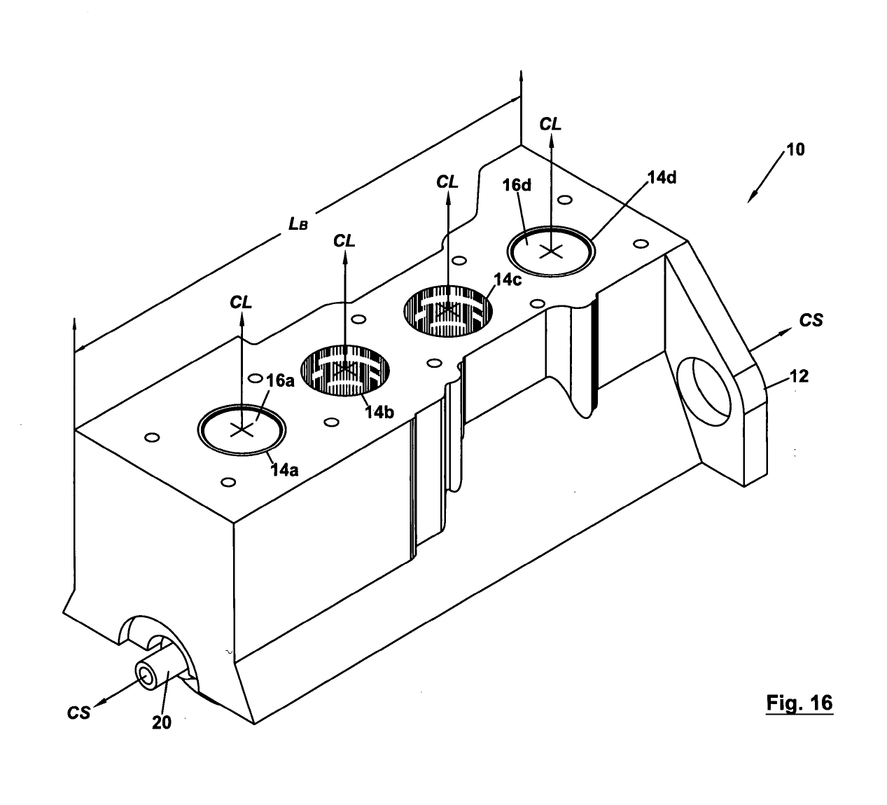

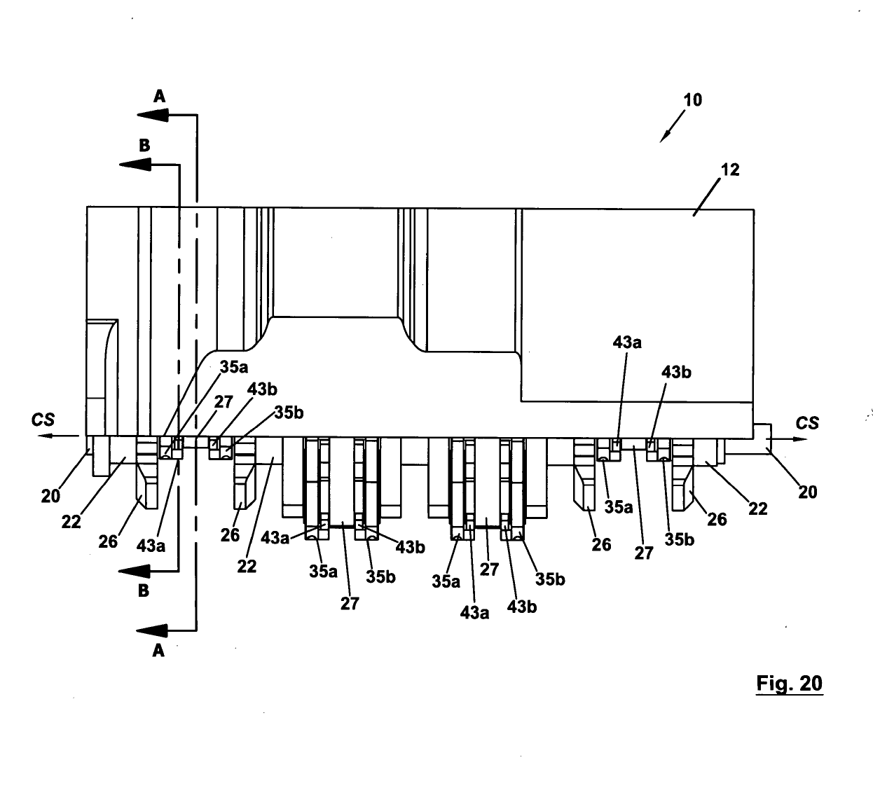

According to some embodiments, crankshaft 20 and/or connecting rod 28 may be configured to provide more control over relative movement between crankpin 24 and connecting rod 28. For example, the exemplary embodiment shown in FIGS. 16-28B includes an exemplary embodiment of crankshaft 20 that includes more than one crankpin cam 27 and an exemplary embodiment of connecting rod 28 that includes more than one follower. This may provide greater control of relative motion between crankpin 24 and connecting rod 28, for example, during an intake stroke of engine 10.

Exemplary engine 10 shown in FIGS. 16-28B is a reciprocating-piston internal combustion engine. As shown in FIG. 16, engine 10 includes a cylinder block 12. According to some embodiments, exemplary cylinder block 12 may have a length L_{B} that is relatively longer than a conventional cylinder block, for example, in order to provide more space relative to a conventional engine to accommodate a crankshaft 20 having longer crankpins 24.

Exemplary cylinder block 12 defines a number of cylinders 14, each defining a longitudinal axis CL. In the exemplary embodiment shown, engine 10 has an in-line configuration and four cylinders 14a, 14b, 14c, and 14d. Although exemplary engine 10 has a configuration commonly referred to as an “in-line four” configuration, engine 10 may have other configurations known to those skilled in the art, such as, for example, configurations commonly referred to as “V,” “W,” “H,” “flat,” “horizontally-opposed,” and “radial.” Further, although exemplary engine 10 has four cylinders, engine 10 may have other numbers of cylinders known to those skilled in the art, such as, for example, one, two, three, five, six, eight, twelve, sixteen, twenty, and twenty-four. Thus, engine 10 may have, for example, any one of configurations commonly referred to as “flat-four,” “flat-six,” “in-line six,” “V-6,” “straight-eight,” “V-8,” “V-10,” “V-12,” “W-12,” and “H-16.” Further, although exemplary engine 10 is described herein in relation to four-stroke operation, other operations known to those skilled in the art are contemplated, such as, for example, two-stroke, three-stroke, five-stroke, and six-stroke operation. Exemplary engine 10 may be a spark-ignition engine, compression-ignition engine, or combinations and/or modifications thereof known to those skilled in the art.

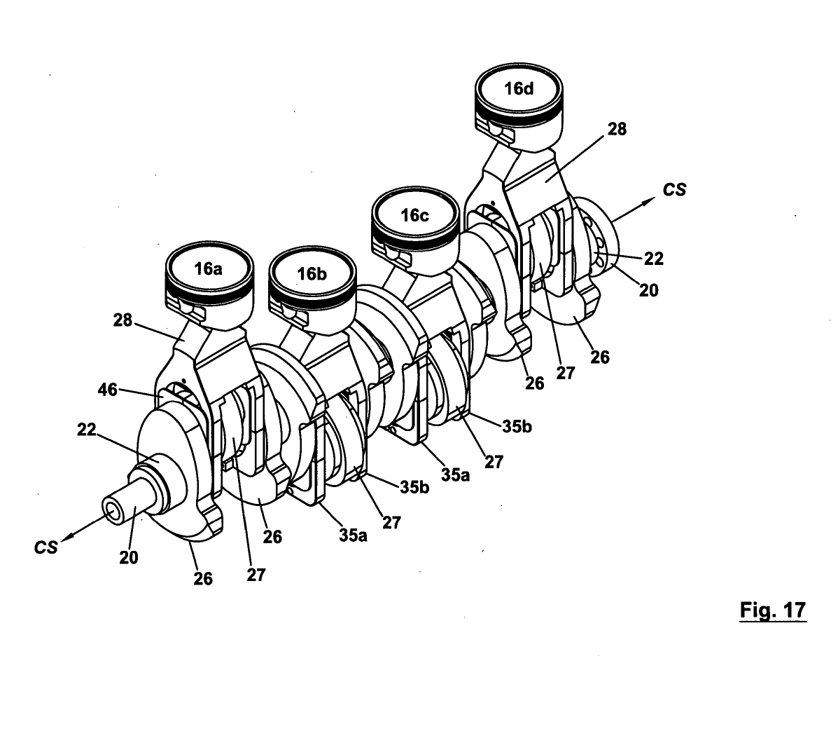

As shown in FIGS. 16 and 17, exemplary engine 10 includes pistons 16 corresponding to cylinders 14, for example, four pistons 16a, 16b, 16c, and 16d. As shown in FIG. 16, pistons 16a and 16d are positioned in the upper end (i.e., “upper” being relative to the orientation of engine 10 shown in FIG. 1) of cylinders 14a and 14d, respectively, while pistons 16b and 16c are not visible in FIG. 16 due to being positioned lower in the cylinders 14b and 14c, respectively. To the extent that the relative positions of the pistons 16 in the cylinders 14 tend to indicate a relative firing order of engine 10 (i.e., the sequential order of combustion events as identified by cylinders), exemplary engine 10 may be configured to have a different firing order, as is known to those skilled in the art.

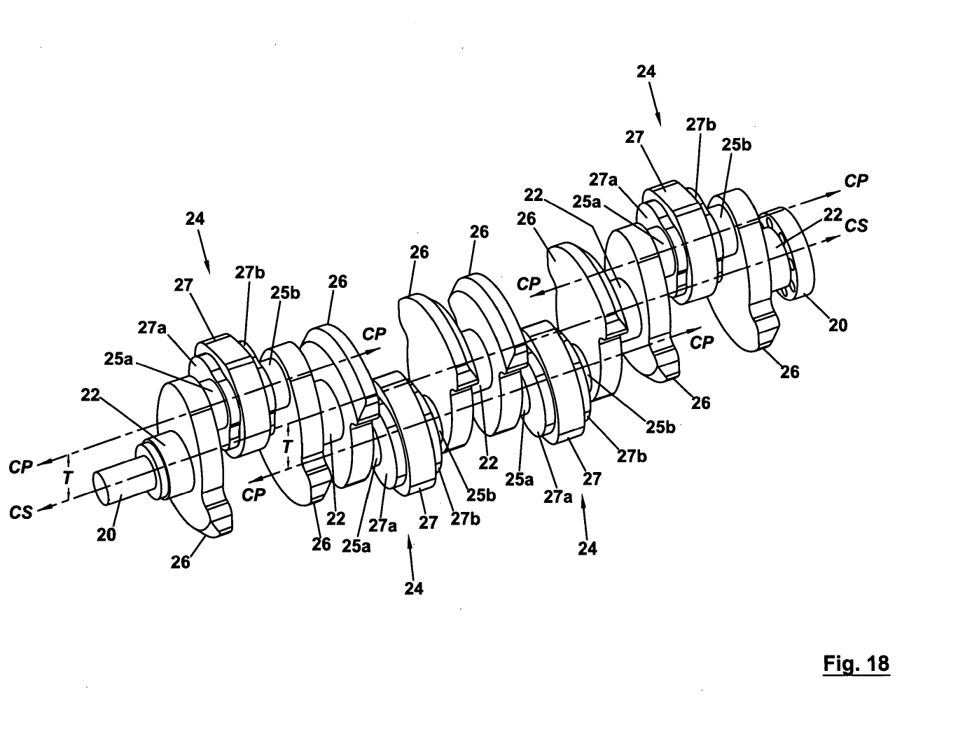

Cylinder block 12 of exemplary engine 10 defines a number of bearings (not shown) for receiving a crankshaft 20, such that crankshaft 20 may rotate relative to cylinder block 12 along a longitudinal crankshaft axis CS defined by crankshaft 20. For example, as shown in FIG. 18, crankshaft 20 defines a number of crankshaft journals 22 having a circular cross-section with a cross-section center. The number of crankshaft journals 22 corresponds to the number of bearings defined by cylinder block 12, and crankshaft journals 22 are received by bearings, such that crankshaft 20 may rotate along longitudinal crankshaft axis CS.

Exemplary crankshaft 20 shown in FIGS. 17 and 18 also defines a number of crankpins 24 corresponding to the number of pistons 16, although the number of crankpins 24 does not necessarily equal the number of pistons 16. As shown in FIG. 18, each of exemplary crankpins 24 includes a pair of crankpin journals 25a and 25b separated by a crankpin cam 27 and a pair of secondary crankpin cams 27a and 27b located on either side of crankpin cam 27. According to some embodiments (not shown), crankshaft 20 may include only a single secondary crankpin cam 27a located to one side of crankpin cam 27.

Exemplary crankpin journals 25a and 25b are circular in cross section, and the respective circular cross-sections may define a center C, which, in turn, defines a longitudinal crankpin axis CP extending in a perpendicular manner through center C of the cross-section of the respective crankpin journals 25a and 25b, such that crankpin axis CP is parallel and offset with respect to crankshaft axis CS. For example, crankpin axis CP is spaced a distance T from the longitudinal axis CS of crankshaft 20. Crankshaft 20 may also include a number of counterbalance weights 26 for providing (or improving) rotational balance of crankshaft 20 when assembled with pistons 16 and connecting rods.

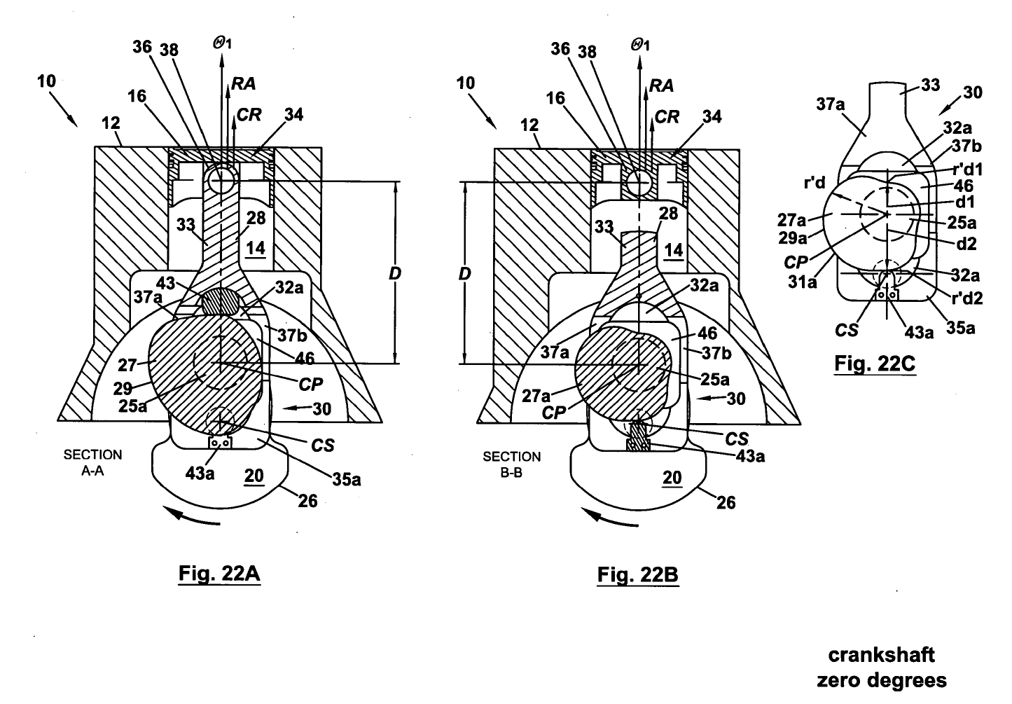

Regarding exemplary crankpin cam 27, as shown in, for example, FIGS. 22A, crankpin cam 27 defines a cam profile 29 corresponding to a radial distance r_{d} from crankpin axis CP to the edge face 31 of cam 27. (See also FIG. 8A, which shows an exemplary cam 27 for the engine embodiment shown in FIGS. 1-15, which is at least similar to exemplary cam 27 shown with respect to the exemplary embodiment of FIGS. 16-28B). Radial distance r_{d} varies from a minimum radial distance to a maximum radial distance to define cam profile 29. In a first direction d₁ extending along a line from the longitudinal crankshaft axis CS toward the longitudinal crankpin axis CP, the radial distance r_{d1} associated with the first direction d₁ is less than the maximum radial distance. Also, in a second direction d₂ extending along a line from the longitudinal crankpin axis CP toward the longitudinal crankshaft axis CS, the radial distance r_{d2} associated with the second direction d₂ is greater than the radial distance r_{d1} associated with the first direction d₁.

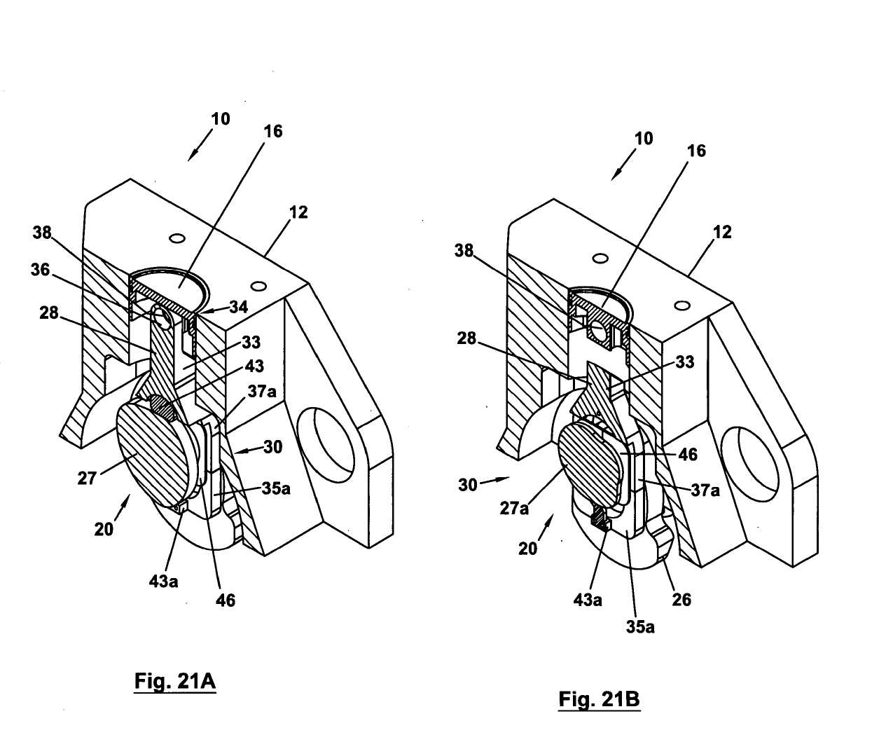

Similar to crankpin cam 27, secondary crankpin cams 27a and 27b define secondary cam profiles 29a and 29b corresponding to radial distances r_{d}′ from crankpin axis CP to the edge faces 31a and 31b of secondary crankpin cams 27a and 27b, respectively, as shown in FIG. 22C. (FIGS. 21A-28B are schematic section views, and thus, they may not show some of the subject matter identified in the descriptions of those figures, such as, for example, second pair of legs 39a and 39b, crankpin journal 25b, secondary crankpin cam 27b, and oblong opening 32b). Radial distances r_{d}′ vary from a minimum radial distance to a maximum radial distance to define secondary cam profiles 29a and 29b. As shown in FIG. 22C, in a first direction d₁ extending along a line from the longitudinal crankshaft axis CS toward the longitudinal crankpin axis CP, the radial distance r′_{d1} associated with the first direction d₁ is less than the maximum radial distance. Also, in a second direction d₂ extending along a line from the longitudinal crankpin axis CP toward the longitudinal crankshaft axis CS, the radial distance r′_{d2} associated with the second direction d₂ is greater than the radial distance r′_{d1} associated with the first direction d₁.

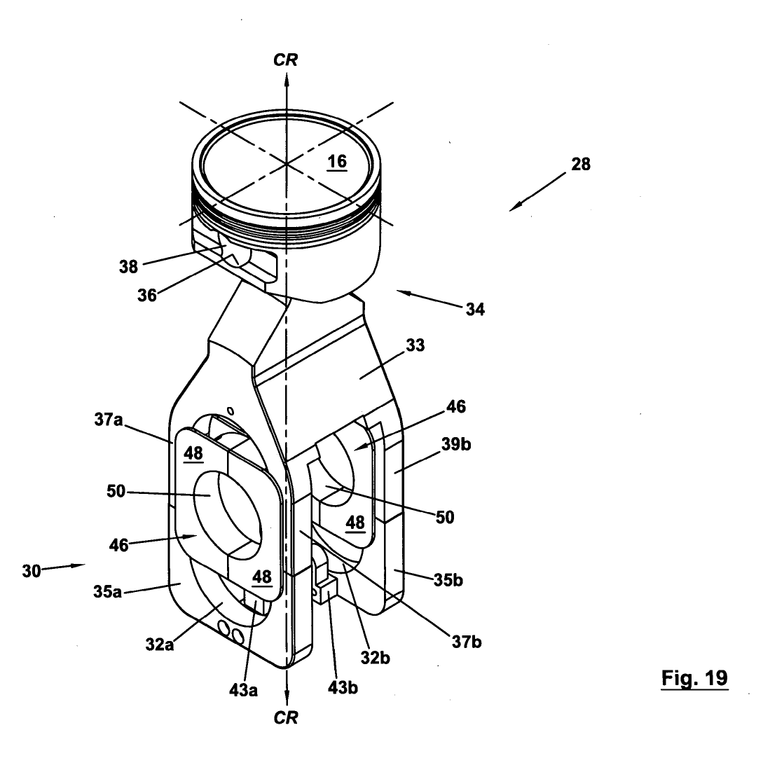

Referring to FIG. 17, for example, pistons 16 are operably coupled to crankpins 24 via a number of respective connecting rods 28 corresponding to the number of pistons 16. For example, exemplary connecting rods 28 (see, e.g., FIG. 19) include a proximal end 30 having an oblong openings 32a and 32b, and a distal end 34 having a second aperture 36. Proximal end 30 of exemplary connecting rod 28 is operably coupled to crankpin 24 of crankshaft 20 via oblong openings 32a and 32b, and distal end 34 of connecting rod 28 is operably coupled to piston 16 via a pin 38.

As shown in FIG. 19, exemplary connecting rod 28 includes a rod portion 33 and two cap portions 35a and 35b, although some embodiments may only include a single cap portion (see, e.g., FIGS. 29A and 29B). Exemplary rod portion 33 and exemplary cap portions 35a and 35b define two oblong openings 32a and 32b, with the oblong openings 32a and 32b each defining a longitudinal axis O, which may generally extend parallel to a longitudinal axis CR of connecting rod 28. Oblong openings 32a and 32b define a width orthogonal to longitudinal axes O that generally corresponds to the cross-section diameter of crankpin journals 25a and 25b, thereby permitting crankpin journals 25a and 25b to move linearly relative to connecting rod 28. This exemplary configuration permits relative linear movement between the longitudinal crankpin axis CP and proximal end 30 of connecting rod 28.

As shown in FIG. 19, exemplary rod portion 33 includes a first pair of legs 37a and 37b and a second pair of legs 39a and 39b spaced from the first pair of legs 37a and 37b, thereby providing a clearance 41 between the first and second pairs of legs. First pair of legs 37a and 37b at least partially defines first oblong opening 32a, and second pair of legs 39a and 39b at least partially defines second oblong opening 32b.

In the exemplary embodiment shown in FIG. 19, sleeves 46 may be provided in oblong openings 32a and 32b. For example, exemplary sleeves shown in FIG. 19 include sleeves halves 48 defining a bearing surface 50 for receiving one of journals 25a and 25b of crankpin 24. Sleeve halves 48 include opposing flanges 52, such that when sleeves 46 are assembled in oblong openings 32a and 32b, the pairs of legs 37a and 37B, and 39a and 39b, are sandwiched between the opposing flanges 52 of respective sleeves 46. Sleeves 46 permit crankpin 24 to reciprocate within oblong openings 32a and 32b, while providing bearing surfaces 50 in which crankpin journals 25a and 25b rotate.

As shown in FIG. 21A, rod portion 33 includes a follower 43 associated with clearance 41. For example, in the exemplary embodiment shown, follower 43 is located in clearance 41 at the apex of first pair of legs 37a and 37b and second pair of legs 39a and 39b. Rod portion 33 of connecting rod 28 is coupled to crankshaft 20 such that first pair of legs 37a and 37b and second pair of legs 39a and 39b are associated with first crankpin journal 25a and second crankpin journal 25b, respectively, with cam 27 of crankpin 24 being positioned in clearance 41 (see FIGS. 18, 21A, and 21B). As shown in FIG. 19, exemplary cap portions 35a and 35b are coupled to first pair of legs 37a and 37b and second pair of legs 39a and 39b, respectively, by cap bolts (see, e.g., FIG. 4), thereby enclosing respective oblong openings 32a and 32b about respective crankpin journals 25a and 25b, with cam 27 and secondary cams 27a and 27b being confined in clearance 41 of connecting rod 28.

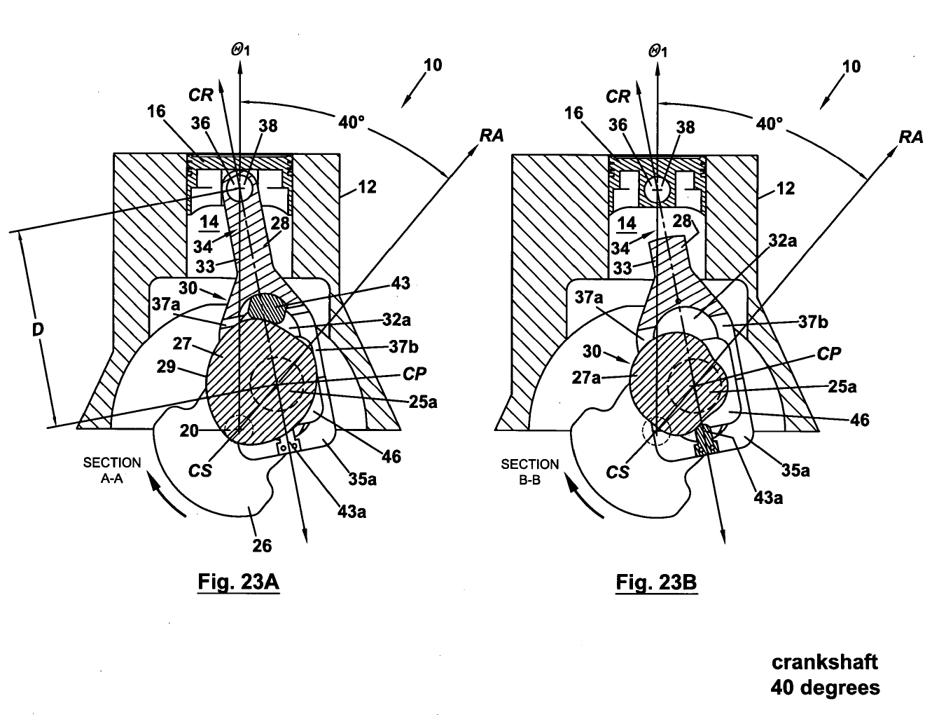

According to the exemplary embodiment shown in FIG. 21A, exemplary follower 43 is configured to oscillate with respect to rod portion 33 to reduce friction and wear between crankpin cam 27 and follower 43. For example, exemplary follower 43 is shaped to have a concave radius adjacent the surface of cam 27 that is the same as the complimentary convex radius of cam profile 29 at the point in which the power stroke begins (e.g., at the radial position of radial axis RA coincident with the end of the delay of the beginning of the power stroke, for example, when radial axis RA is 40 degrees past first stroke termination angle θ₁ (see, e.g., FIG. 23B)). Such an exemplary configuration serves to increase the area of contact between follower 43 and cam 27, thereby reducing friction and/or wear of cam 27 and/or follower 43.

In the exemplary embodiment shown in FIG. 21A, exemplary follower 43 also includes a convex radius adjacent a complimentary surface of rod portion 33 against which follower 43 oscillates. This exemplary configuration serves to increase the area of contact between follower 43 and the surface of rod portion 33, thereby reducing friction and/or wear of follower 43 and/or rod portion 33.

According to some embodiments, follower 43 may include an arc-shaped slot (not shown), and rod portion 33 includes a pin (not shown), such that as the surface of cam 27 rides against follower 43, follower 43 oscillates relative to rod portion 33, for example, as shown in FIGS. 21A, 22A, 23A, 24A, 25A, 26A, 27A, and 28A. This serves to maintain an increased area of contact between follower 43 and the surface of cam 27 and rod portion 33, thereby reducing friction and/or wear of cam 27, rod portion 33, and/or follower 43. According to some embodiments (not shown), rod portion 33 may include an arc-shaped slot, and follower 43 includes a pin, such that as the surface of cam 27 rides against and passes follower 43, follower 43 oscillates relative to rod portion 33.

In the exemplary embodiment shown, cap portions 35a and 35b of connecting rod 24 include respective secondary followers 43a and 43b configured to follow respective secondary crankpin cams 27a and 27b. For example, in the exemplary embodiment shown in FIG. 21B and with reference to FIG. 19, secondary followers 43a and 43b are located at the apexes of the cap-ends of oblong openings 32a and 32b. Rod portion 33 of and cap portions 35a and 35b of connecting rod 28 are coupled to crankshaft 20 such secondary crankpin cams 27a and 27b are aligned with secondary followers 43a and 43b, respectively (see FIGS. 18, 21A, and 21B). Some embodiments may include only a single secondary crankpin cam and a single secondary follower. Secondary crankpin cams 27a and 27b and secondary followers 43a and 43b may serve to pull connecting rod 28 and piston 16 down cylinder 14 during the intake stroke of engine 10 (i.e., when engine 10 is a four-stroke engine), during which crankshaft 20 operates to pull piston 16 down cylinder 14 due to the lack of combustion force on piston 16. Interaction between secondary crankpin cams 27a and 27b and secondary followers 43a and 43b transmits the pulling force from crankpin 24 to piston 16 via secondary crankpin cams 27a and 27b, secondary followers 43a and 43b, and connecting rod 28 by preventing crankpin 24 from sliding in an unrestrained manner within oblong openings 32a and 32b. (See, e.g., FIGS. 19, 23B, 24B, and 25B.)

With reference to FIG. 19 and, as shown in, for example, FIGS. 21B and 22B, secondary followers 43a and 43b may include one end coupled to respective cap portions 35a and 35b of connecting rod 24 via, for example, pins, bolts, and/or other fasteners or methods. The other end of exemplary secondary followers 43a and 43b includes a rounded portion configured to contact and ride against secondary crankpin cams 27a and 27b as crankshaft 20 rotates. According to some embodiments, secondary followers 43a and 43b may be configured similar to exemplary follower 43 shown in FIGS. 21B-28A/Follower 43 and/or secondary followers 43a and 43b may have various structures, such as, for example, rollers.

One or more of crankpin cam 27, secondary crankpin cams 27a and 27b, follower 43, and secondary followers 43a and 43b may be formed from a hardened material configured to withstand the friction associated with interaction between the cams and followers. For example, one or more of the cams and followers may be formed from hardened bearing material known to those skilled in the art. According to some embodiments, one or more of followers 43 and secondary followers 43a and 43b may be mounted in a biased manner such the follower(s) are biased to contact a corresponding cam. Such biasing force may be provided by, for example, a spring and/or a hydraulic biasing force. Such biasing may serve, for example, to maintain contact between secondary crankpin cams 27a and 27b and secondary followers 43a and 43b and/or reduce noise associated with operation exemplary engine 10.

According to some embodiments, crankpin cam 27, secondary crankpin cams 27a and 27a, follower 43, and/or secondary followers 43a and 43b may be configured such that crankpin cam 27 is in contact with follower 43 throughout the 360-degree rotation of radial axis RA, and/or such that secondary crankpin cams 27a and 27b are in contact with secondary followers 43a and 43b, respectively, throughout the 360-degree rotation of radial axis RA. In this manner, relative movement between crankpin 24 and connecting rod 28 may be more closely controlled throughout the 360-degree rotation of radial axis RA. According to some embodiments, relative movement between crankpin 24 and connecting rod 28 may not be controlled throughout the entire 360-degree rotation of radial axis RA.

With exemplary crankpin 24 and connecting rod 28 coupled to one another in this exemplary manner, cam profile 29 of crankpin cam 27 of crankpin 24 interacts with follower 43 of connecting rod 28, such that as crankshaft 20 rotates, crankpin 24 rotates relative to connecting rod 28. Follower 43 rides on crankpin cam 27, and secondary followers 43a and 43b ride on secondary crankpin cams 27a and 27b, and as the radial distance r_{d} of cam profile 29 varies, proximal end 30 connecting rod 28 moves linearly with respect to longitudinal crankpin axis CP by virtue of crankpin journals 25a and 25b reciprocating along the longitudinal axis O within oblong openings 32a and 32b, as explained in more detail with respect to FIGS. 22A-28B. As a result of this exemplary configuration, the stroke of exemplary engine 10 is affected according to interaction between crankpin cams 27, 27a, and 27b, and followers 43, 43a, and 43b. As explained in more detail herein, this exemplary configuration may permit tailoring of the operation characteristics (e.g., power output, torque, efficiency, and/or responsiveness) of exemplary engine 10.

According to the exemplary embodiment shown in FIGS. 16-28B, interaction between crankpin 24 and connecting rod 28 may be configured such that substantial movement of piston 16 toward crankshaft 20 during the power stroke is delayed until crankshaft 20 has rotated to point at which there is a more effective moment arm between the transmission of the combustion force on piston 16 and a radial axis RA extending between crankshaft axis CS and a respective crankpin axis CP. For example, cam profile 29 of cam 27 may be shaped such that crankpin 24 moves within oblong openings 32a and 32b as crankshaft 20 rotates without any movement, or without any significant amount of movement, of distal end 34 of connecting rod 28, thereby effectively increasing the distance between the center C of crankpin 24 and distal end 34 of connecting rod 28. As a result, a greater amount of the energy of the combustion event may be captured because the maximum force acting on piston 16 coincides with a greater moment arm, thereby resulting in more torque at crankshaft 20 during the power stroke. Timing of initiation of combustion may be tailored to take advantage of the delayed stroke.

During operation of exemplary engine 10, as crankshaft 20 rotates, crankpins 24 revolve around crankshaft longitudinal axis CS, such that crankpin centers C define a circular path having a radius defined by the distance T defined along a radial axis RA (see FIGS. 22A-28B) extending between the longitudinal axis CS of crankshaft 20 and the longitudinal axis CP of the respective crankpins 24. Thus, proximal ends 30 of connecting rods 28, which are coupled to crankpins 24 via oblong openings 32a and 32b of connecting rods 28, move based on the profiles of cams 27, 27a, and 27b, as explained in more detail below with respect to FIGS. 22A-28B. Distal ends 34 of connecting rods 28 are constrained to move in a reciprocating and linear manner due to being operably coupled to pistons 16, which are likewise constrained to move in a reciprocating and linear manner within respective cylinders 14 defined by cylinder block 12. As a result, as crankshaft 20 rotates, pistons 16 reciprocate within respective cylinders 14, defining a piston stroke generally corresponding to twice the distance T between the crankpin axis CP and the crankshaft axis CS (as affected according to the exemplary operation described herein).

Exemplary engine 10 may be configured to selectively employ a strategy that delays substantial movement of piston 16 toward crankshaft 20 during the power stroke, until crankshaft 20 has rotated to a point at which there is a more effective moment arm between the combustion force on piston 16 and radial axis RA extending between crankshaft axis CS and a respective crankpin axis CP. As a result, a greater amount of the energy of the combustion event may be captured because the maximum force acting on piston 16 coincides with a greater moment arm, thereby resulting in more torque at crankshaft 20 during the power stroke. Timing of the initiation of combustion may be tailored to take advantage of the delayed stroke.

FIGS. 22A-28B schematically illustrate exemplary operation of engine 10 having the exemplary configuration, which may serve to delay piston 16's travel down cylinder 14 at the beginning of the power stroke of engine 10. For example, follower 43 of connecting rod 28 interacts with cam 27 of crankpin 24, resulting in crankpin journals 25a and 25b reciprocating within oblong openings 32a and 32b, thereby effectively altering the effective length of connecting rod 28. As shown in FIGS. 22A and 22B, cam profile 29 has a radial distance r_{d} from longitudinal crankpin axis CP that varies, such that crankpin 24 moves within oblong openings 32a and 32b as crankshaft 20 rotates without moving distal end 34 of connecting rod 28, thereby effectively increasing the distance D between the center C of crankpin 24 and distal end 34 of connecting rod 28. Such an exemplary embodiment renders it possible to effectively hold piston 16 in cylinder 14 at a substantially fixed position for a short period of time, even as crankpin 24 continues to revolve around crankshaft 20's axis CS as crankshaft 20 rotates. According to some embodiments, piston 16 may continue to travel up cylinder 14 for this short period of time. As a result, it is possible to position piston 16 at the point of highest compression in the combustion chamber while crankpin 24 revolves to a position, which results in an increased moment arm defined by the transmission of the force acting on piston 16 and the radial axis RA extending between the center of crankshaft 20 and the center C of crankpin 24. This results in relatively more torque being applied to crankshaft 20 as combustion begins, with piston 16 being at a point farthest from the center of crankshaft 20 (i.e., at the end of its upward stroke as shown). In this exemplary manner, the delaying strategy outlined below may be implemented.

For example, as shown in FIGS. 22A and 22B, crankshaft 20 is oriented such that radial axis RA defined by the center of crankshaft 20 and the center C of crankpin 24 is oriented at zero degrees, which corresponds generally to a first stroke termination angle θ₁ that generally coincides with the end of the compression stroke (and exhaust stroke in a four-stroke engine) of exemplary engine 10. Thus, with radial axis RA in this orientation, piston 16 is at its upper position within cylinder 14. According to some embodiments, piston 16 may be continuing to travel up cylinder 14 at this radial axis position.

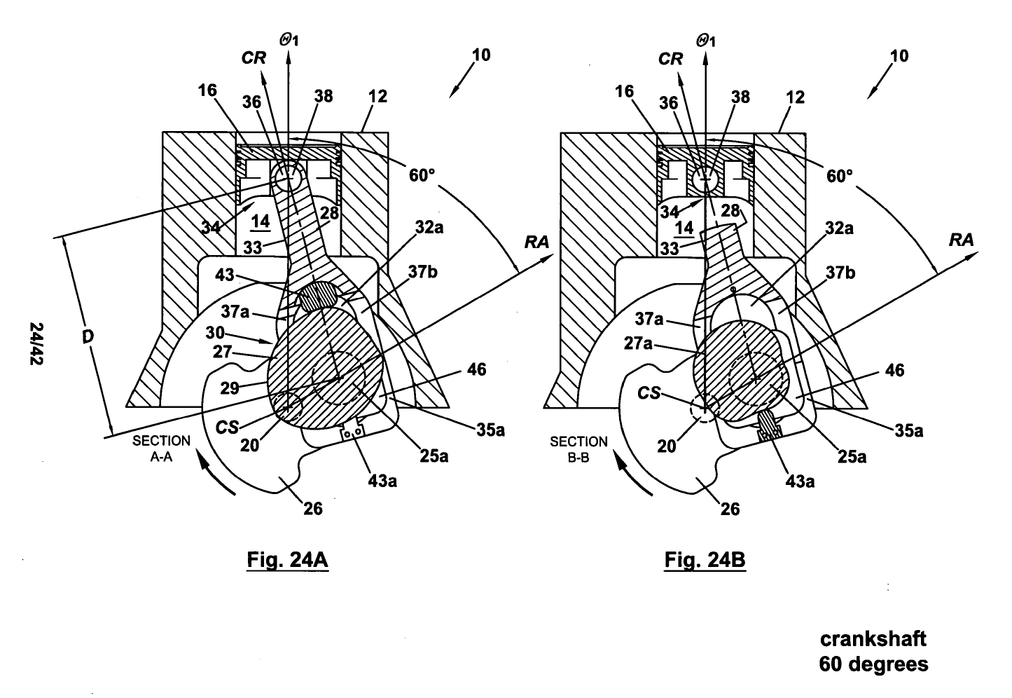

As shown in FIG. 22A, during operation of engine 10, crankshaft 20 rotates in the clockwise direction. With cam 27 and follower 43 interacting as shown, crankpin journals 25a and 25b are located generally centrally within the length of oblong openings 32a and 32b, such that piston 16 is at the top of its stroke while radial axis RA of crankshaft 20 is substantially aligned with the longitudinal axis CR of connecting rod 28. This position and exemplary configuration results in the distance D between the center C of crankpin 24 and distal end 34 (e.g., the center of second aperture 36) of connecting rod 28 being reduced relative to the distance D shown in, for example, FIGS. 24A-26B.

Referring to FIG. 22B, in the exemplary case where engine 10 is a four-stroke engine, during the intake stroke crankshaft 20 acts to pull piston 16 down cylinder 14 instead of combustion driving piston 16 down cylinder 14. As shown in FIG. 22B, secondary crankpin cams 27a and 27b and secondary crankpin followers 43a and 43b serve to transfer force from crankpin 24 of crankshaft 20 to connecting rod 28. As shown in FIGS. 22A and 22B, the combination of the interaction between crankpin cam 27 and follower 43, and the interaction between secondary crankpin cams 27a and 27b and secondary crankpin followers 43a and 43b, serve to position sleeves 46 in oblong openings 32a and 32b in a stable manner, such that the position of crankpin 24 is controlled by the combination of cam and follower interactions.

FIGS. 23A and 23B and show crankshaft 20 in an orientation where radial axis RA has rotated 40 degrees past first stroke termination angle θ₁. In a conventional engine, piston 16 would have traveled a significant distance toward crankshaft axis CS as radial axis RA rotates through 40 degrees. In contrast, according to exemplary engine 10, piston 16 has not yet started its downward travel toward crankshaft axis CS. Instead, cam 27 has rotated relative to oblong openings 32a and 32b such that interaction between cam 27 and follower 43 results in crankpin journals 25a and 25b moving down (in the orientation shown) within oblong openings 32a and 32b to a position more remote from the central portion of oblong openings 32a and 32b in a manner resulting in substantially no movement of distal end 34 of connecting rod 28. In particular, radial distance r_{d} of cam profile 29 has increased (compare FIGS. 22A and 23A), thereby forcing crankpin journals 25a and 25b down oblong openings 32a and 32b. As a result, the distance D between the center C of crankpin 24 and distal end 34 of connecting rod 28 has increased relative the distance D shown in FIGS. 22A and 22B. As a result of this increase in the distance D, piston 16 has not started to travel down cylinder 14, even though crankpin 24 has rotated clockwise relative to the center C of crankshaft 20, such that the center CP of crankpin 24 is farther from the top of cylinder 14. (See Table 2 below showing an exemplary relationship for exemplary engine 10 between radial axis RA's angle and piston 16's displacement relative to the first stroke termination angle θ₁.) As a result, the distance D increases, such that rather than beginning downward travel in cylinder 14, piston 16 remains substantially in its position of maximum stroke (i.e., as shown in Table II, piston 16 has moved only 0.037 inch in this example). As shown in FIG. 22B, secondary crankpin cams 27a and 27b and secondary crankpin followers 43a and 43b maintain contact with one another, and during an intake stroke, where no combustion force is acting on piston 16, secondary cams 27a and 27b and secondary followers 43a and 43b serve to transfer force from crankpin 24 of crankshaft 20 to connecting rod 28.

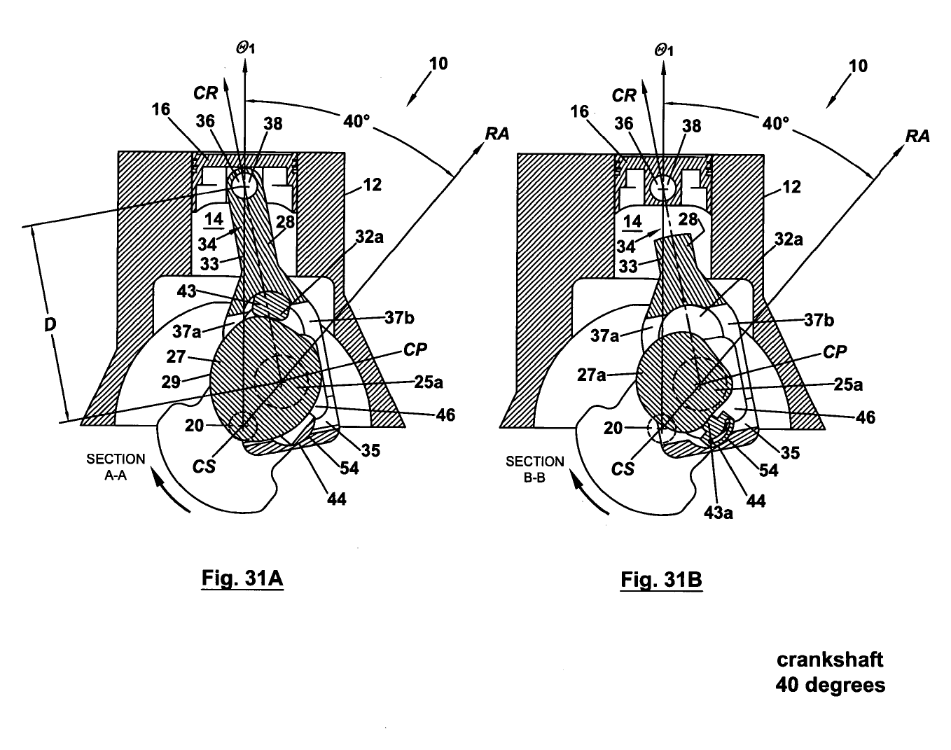

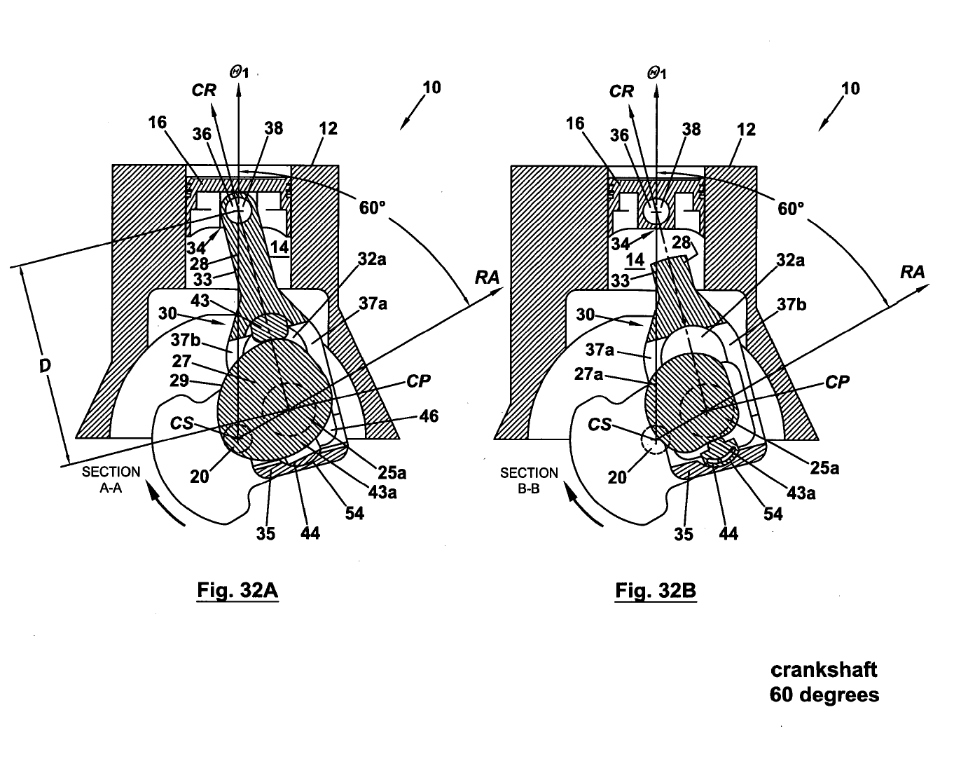

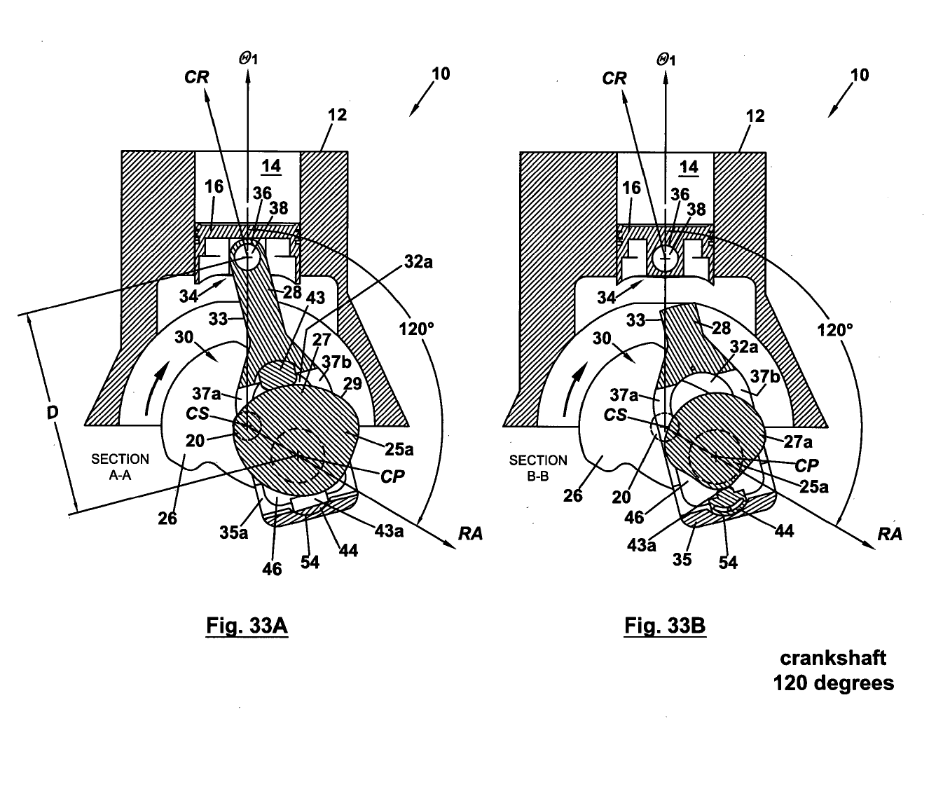

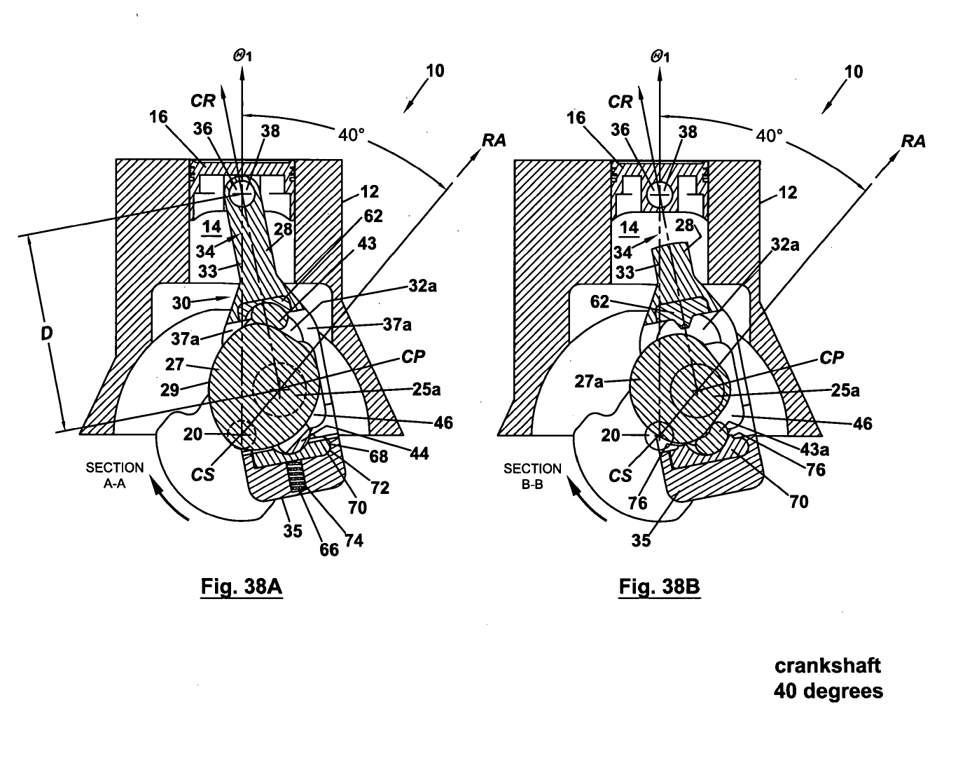

TABLE 2
RADIAL AXIS RA ANGLE VS. PISTON DISPLACEMENT
RELATIVE TO ZERO DEGREES FOR FIGS. 17-42B

| Crank Angle | Piston Depth |
|---|---|
| 0 | 0.000 |
| 4 | 0.006 |
| 8 | 0.006 |
| 12 | 0.008 |
| 16 | 0.013 |
| 20 | 0.018 |
| 24 | 0.022 |
| 28 | 0.025 |
| 32 | 0.028 |
| 36 | 0.032 |
| 40 | 0.037 |
| 44 | 0.057 |
| 48 | 0.110 |
| 52 | 0.191 |
| 56 | 0.293 |
| 60 | 0.414 |
| 64 | 0.558 |
| 68 | 0.704 |
| 72 | 0.852 |
| 76 | 0.999 |
| 80 | 1.146 |
| 84 | 1.290 |
| 88 | 1.432 |
| 92 | 1.571 |
| 96 | 1.706 |
| 100 | 1.836 |
| 104 | 1.962 |
| 108 | 2.082 |
| 112 | 2.196 |
| 116 | 2.304 |
| 120 | 2.406 |
| 124 | 2.501 |
| 128 | 2.589 |
| 132 | 2.671 |
| 136 | 2.746 |
| 140 | 2.813 |
| 144 | 2.874 |
| 148 | 2.928 |
| 152 | 2.974 |
| 156 | 3.014 |
| 160 | 3.047 |
| 164 | 3.072 |
| 168 | 3.091 |
| 172 | 3.103 |
| 176 | 3.116 |
| 180 | 3.129 |

For example, as shown in FIGS. 23A and 23B, the combination of the interaction between crankpin cam 27 and follower 43, and the interaction between secondary crankpin cams 27a and 27b and secondary crankpin followers 43a and 43b continues to position sleeves 46 in oblong openings 32a and 32b in a stable manner, such that crankpin 24 is held in position by the combination of cam and follower interactions. Thus, during an intake stroke, crankshaft 20 continues to pull piston 16 down cylinder 14.

Referring to FIGS. 24A and 24B, in the exemplary embodiment shown, when the radial axis RA has rotated to 60 degrees past the first stroke termination angle θ₁, combustion has commenced, thereby driving piston 16 partially down cylinder 14. Cam 27 has rotated relative to oblong openings 32a and 32b such that interaction between cam profile 29 and follower 43 results in crankpin journals 25a and 25b moving to the end of oblong openings 32a and 32b remote from rod portion 33 of connecting rod 28. Radial distance r_{d} of cam profile 29 has continued to increase, resulting in crankpin journals 25a and 25b being forced farther down oblong openings 32a and 32b. As a result, the distance D between the center C of crankpin 24 and distal end 34 of connecting rod 28 has increased slightly relative the distance D shown in FIGS. 23A and 23B. Thus, between 40 and 60 degrees past the first stroke termination angle θ₁, crankpin journals 25a and 25b have almost reached the end of oblong openings 32a and 32b. At this radial position, follower 43 of rod portion 33 acts against cam 27, and piston 16 begins travel down cylinder 14 toward longitudinal crankshaft axis CR. In particular, in the example shown, piston 16 has traveled 0.377 inch down cylinder 14 as radial axis RA has rotated from 40 to 60 degrees past stroke termination angle θ₁, which is more than ten times as far as piston 16 traveled between 0 degrees and 40 degrees.

At this position of radial axis RA, radial axis RA is no longer aligned with the longitudinal axis CR of connecting rod 28. As combustion force on piston 16 pushes down on cam 27 and causes force on piston 16 to be directed to crankpin 24. This exemplary arrangement results in an increased moment arm for driving crankshaft 20 in the clockwise direction (as shown). As compared to an engine having a conventional architecture, this results in relatively more torque being applied to crankshaft 20 as combustion begins between 40 and 60 degrees past first stroke termination angle θ₁. As a result of crankpin journals 25a and 25b moving to the end of oblong openings 32a and 32b remote from distal end 34 of connecting rod 28, the distance D between the center C of crankpin 24 and distal end 34 of connecting rod 28 has continued to increase relative to the distance D shown in FIGS. 23A and 23B.

Although the exemplary embodiment shown in FIGS. 22A-28B shows the point at which piston 16 begins to move from its point of maximum stroke to be where radial axis RA has rotated 40 degrees past first stroke termination angle θ₁, this point may be between 40 and 60 degrees past first stroke termination angle θ₁ (e.g., 59 degrees, 55 degrees, 50 degrees, 45 degrees, or 41 degrees). According to some embodiments, the point at which piston 16 begins to move from its point of maximum stroke may be less than 40 degrees past first stroke termination angle θ₁. According to some embodiments, the radial position of crankshaft 20 at which the piston 16 begins to move from its point of maximum stroke may be adjusted during operation according to predetermined criteria in order to tailor operation of engine 10.

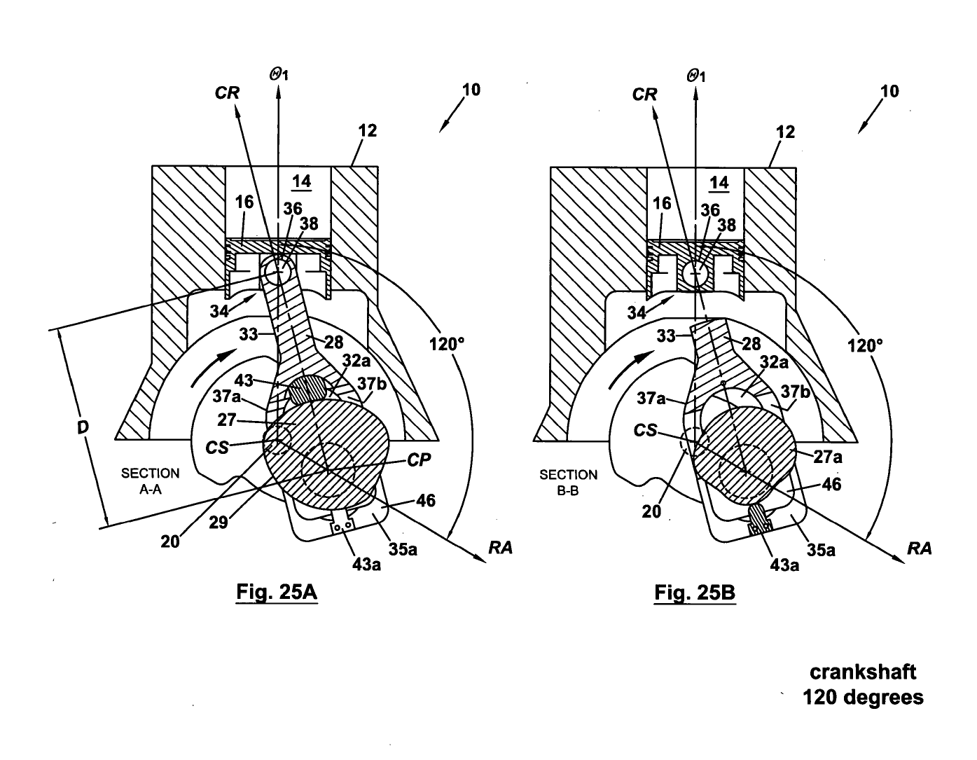

Referring to FIGS. 25A and 25B, radial axis RA has rotated 120 degrees past first stroke termination angle θ₁. As shown, cam 27 and follower 43 interact such that crankpin journals 25a and 25b remain in substantially the same position in oblong openings 32a and 32b as shown in FIGS. 24A and 24B. Radial distance r_{d} of cam profile 29 has remained substantially the same, resulting in crankpin journals 25a and 25b remaining at substantially the same position within oblong openings 32a and 32b. As a result, the distance D between the center C of crankpin 24 and distal end 34 of connecting rod 28 has remained substantially the same relative the distance D shown in FIGS. 24A and 24B. As a result, piston 16 has traveled farther down cylinder 14. In the example shown, piston 16 has traveled 2.406 inches from its position at stroke termination angle θ₁. Because crankpin journals 25a and 25b have remained in substantially the same position in oblong openings 32a and 32b as shown in FIGS. 24A and 24B, the distance D between the center C of crankpin 24 and distal end 34 of connecting rod 28 has not significantly changed relative to the distance D shown in FIGS. 24A and 24B.

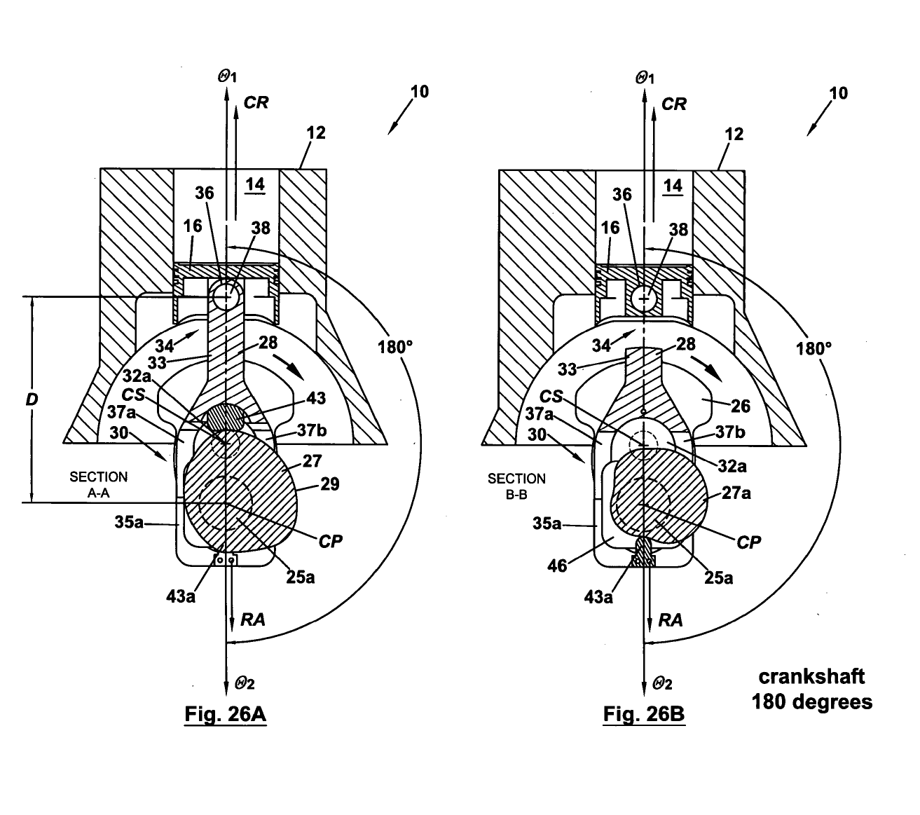

As shown in FIGS. 26A and 26B, radial axis RA has rotated to 180 degrees past the first stroke termination angle θ₁ (i.e., at a second stroke termination angle θ₂, which corresponds generally to the end of the power stroke). Cam 27 and follower 43 interact such that crankpin journals 25a and 25b approach the end of exemplary oblong openings 32a and 32b. Radial distance r_{d} of cam profile 29 has increased further still, resulting in crankpin journals 25a and 25b being forced farther down oblong openings 32a and 32b. As a result, the distance D between the center C of crankpin 24 and distal end 34 of connecting rod 28 has increased slightly relative to the distance D shown in FIGS. 25A and 25B. As a result, piston 16 travels farther down cylinder 14 to a point 3.129 inches from its position at stroke termination angle θ₁.

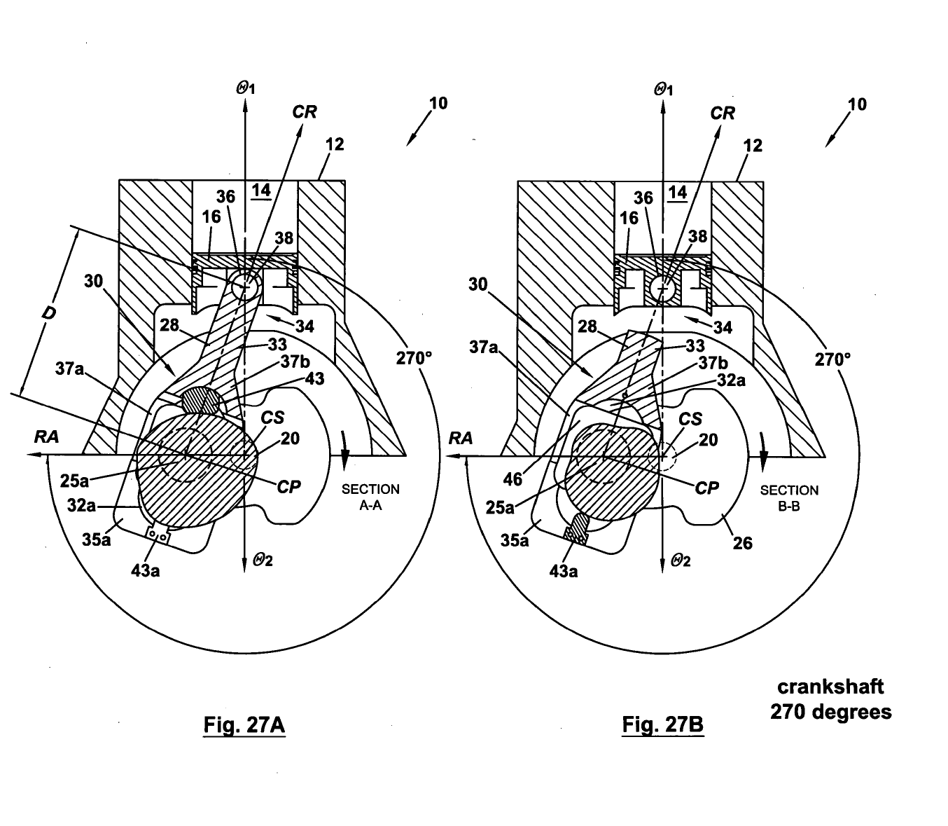

Referring to FIGS. 27A and 27B, radial axis RA has rotated to 270 degrees past the first stroke termination angle θ₁ (i.e., 90 degrees past second stroke termination angle θ₂). Cam 27 and follower 43 interact such that crankpin journals 25a and 25b have returned to a more generally central position within oblong openings 32a and 32b. In particular, radial distance r_{d} of cam profile 29 has decreased significantly relative to FIGS. 26A and 26B, resulting in crankpin journals 25a and 25b being forced back to generally the central portion of oblong openings 32a and 32b. As a result, the distance D between the center C of crankpin 24 and distal end 34 of connecting rod 28 has decreased relative to the distance D shown in FIGS. 26A and 26B. Even though the distance D has shortened, piston 16 has reversed its direction of travel within cylinder 14 and started moving away from longitudinal crankshaft axis CR.

As shown in FIGS. 26A-27B, between 180 and 270 degrees past first stroke termination angle θ₁, piston 16 travels up cylinder 14, thereby commencing an exhaust and/or compression stroke. During this time, crankshaft 20 is driving piston 16 up into cylinder 14. Thus, the interaction between crankpin cam 27 and crankpin follower 43 transfers force between crankshaft 20 and connecting rod 28. Interaction between secondary crankpin cams 43a and 43b and secondary crankpin followers 43a and 43b stabilize this interaction such that sleeves 46 do not slide in an uncontrolled manner within oblong openings 32a and 32b.

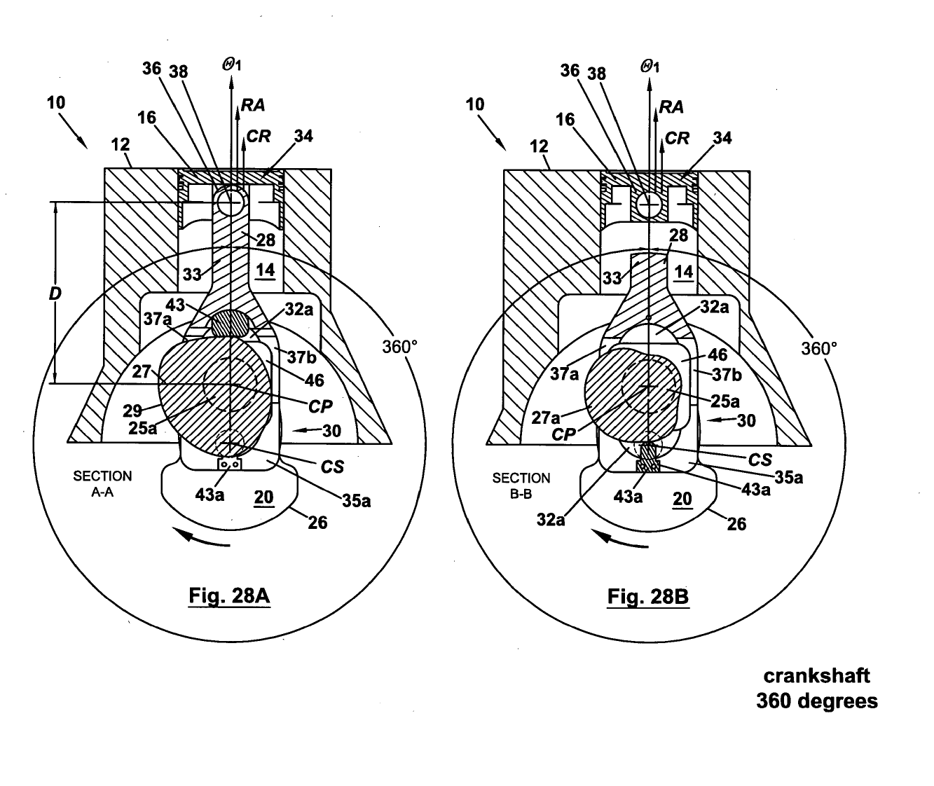

Referring to FIGS. 28A and 28B, radial axis RA has rotated to 360 degrees past the first stroke termination angle θ₁, and thus, has returned to the first stroke termination angle θ₁ shown in FIGS. 22A and 22B. As shown in FIGS. 28A and 28B, cam profile 29 and follower 43 have interacted such that crankpin journals 25a and 25b remain in substantially the same position in oblong openings 32a and 32b as shown in FIGS. 27A and 27B. As a result, radial distance r_{d} of cam profile 29 has remained substantially the same, resulting in crankpin journals 25a and 25b remaining at substantially the same position within oblong openings 32a and 32b. As a result, the distance D between the center C of crankpin 24 and distal end 34 of connecting rod 28 has remained substantially the same relative to the distance D shown in FIGS. 27A and 27B. However, relative to FIGS. 26A and 26B, distance D between the center C of crankpin 24 and distal end 34 of connecting rod 28 has decreased and has partially offset the movement of crankpin 24 toward piston 16 as radial axis RA has rotated from 180 degrees to 360 degrees past the first stroke termination angle θ₁.

In the exemplary manner described above, the distance D between the center C of crankpin 24 and distal end 34 of connecting rod 28 is variable, such that the distance between the center C of crankpin 24 and distal end 34 of connecting rod 28 (e.g., the center of pin 38) is variable. More specifically, the distance D is variable (see, e.g., FIGS. 22A and 22B), the variability of the distance D being facilitated in the exemplary embodiment by virtue of crankpin 24 and connecting rod 28. As radial axis RA rotates between first stroke termination angle θ₁ and 180 degrees past first stroke termination angle θ₁ (i.e., to second stroke termination angle θ₂), the distance D initially increases, thereby delaying initiation of the power stroke until radial axis RA reaches a point, for example, at least 40 degrees past first stroke termination angle θ₁ in the exemplary embodiment shown. Timing of the initiation of combustion may be tailored to take advantage of this delay. The distance D may remain relatively constant as radial axis RA continues to rotate toward an orientation 180 degrees past first stroke termination angle θ₁ (FIGS. 22A-26B). As the radial axis RA rotates between 180 and 360 degrees past first stroke termination angle θ₁, the distance D is decreases (FIGS. 26A-28B).

According to some embodiments, the exemplary configuration and/or interaction between crankshaft 20 and connecting rod 28 may be tailored to achieve desired performance characteristics of exemplary engine 10, such as, for example, improved efficiency, improved torque, improved power output, and/or improved responsiveness. For example, profile 29 of crankpin cam 27 may be configured to improve efficiency and/or power of exemplary engine 10, for example, by changing at least one of the timing and magnitude of the delay of initiation of the power stroke.

According to some embodiments, initiation of the power stroke of exemplary engine 10 may be delayed until radial axis RA has rotated at least about 15 degrees beyond the first stroke termination angle θ₁. In other embodiments, initiation of the power stroke may be delayed until radial axis RA has rotated at least about 30 degrees beyond the first stroke termination angle θ₁ (e.g., at least about 40 or 45 degrees beyond the first stroke termination angle θ₁). In other embodiments, rotation may be set to about 25 or 35 degrees beyond the first stroke termination angle θ₁, for example, to achieve a desired performance characteristic of engine 10.

According to some embodiments, depending on, for example, profile 29 of crankpin cam 27, piston 16 may continue to travel slightly up into cylinder 14 as radial axis RA rotates between 0 degrees and, for example, 40 degrees past first stroke termination angle θ₁, with the downward travel of piston 16 within cylinder 14 beginning thereafter at the end of the delay of the power stroke. In other words, during the delay of the power stroke, piston 16 is not necessarily stationary in cylinder 14, but rather, piston 16 may continue its upward travel in cylinder 14 relative to its position in cylinder 14 as radial axis RA passes 0 degrees relative to first stroke termination angle θ₁.

Cam profile 29 of crankpin cam 27 and/or the profiles of secondary crankpin cams 27a and 27b may be selected to facilitate a desired speed and/or acceleration of the travel of piston 16 within cylinder 14. For example, cam profile 29 of crankpin cam 27 may be configured to provide a relatively faster travel and/or higher acceleration following the end of the delay of the beginning of the power stroke. Such cam profile tailoring may be performed to provide a desired power, torque, and/or efficiency of engine 10. Cam profiles of secondary crankpin cams 27a and 27b may also be configured in a similar manner to achieve similar results.

According to some embodiments, engine 10 may be configured to selectively operate in at least two modes. For example, in a first mode of operation the distance D between the between the center C of crankpin 24 (e.g., the longitudinal axis CP of crankpin 24) and distal end 34 of connecting rod 28 may vary in a constant manner as described above. In a second mode of operation, the relationship between the profiles of cams 27, 27a, and/or 27b and crankpin 24 may be variable in a radial manner, such that the delay in the power stroke of piston 16 may be varied according to a desired tailoring. This may be accomplished via, for example, cam phasing, where cam 27 may rotate relative to crankpin journals 25a and 25b, thereby changing the position of radial axis RA at which the power stroke begins. In this exemplary second mode of operation, it may be possible to tailor operation of engine 10 to vary the power output, torque, and/or efficiency of the operation of engine 10 according to operating parameters. According to some embodiments, engine 10 may operate according to a combination of the first and second modes. According to some embodiments, cam phasing may be implemented with secondary cams 27a and 27b.

According to some embodiments, the followers 43, 43a, and/or 43b may be configured to reduce friction and/or wear of the followers and/or cams. For example, FIGS. 29A-35B show an exemplary connecting rod 28 that includes exemplary secondary crankpin followers 43a and 43b that may provide relatively reduced wear and/or friction as compared to the exemplary secondary followers 43a and 43b shown in FIGS. 19 and 21A-28B.

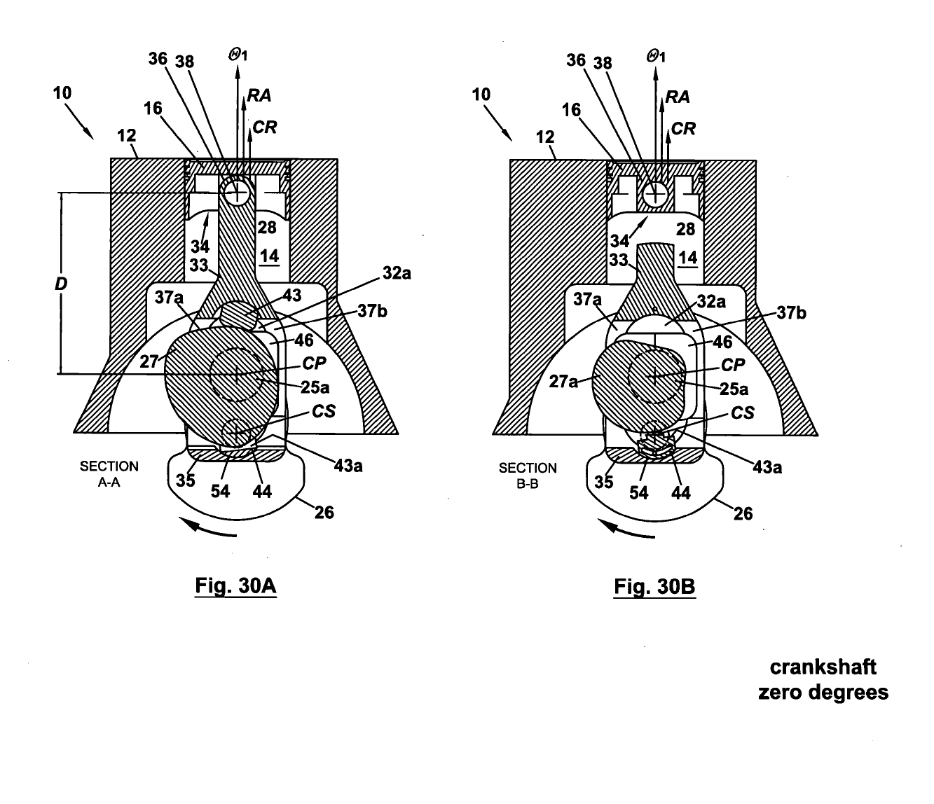

Referring to FIGS. 29A-30B, exemplary connecting rod 28 is similar to the exemplary connecting rod 28 shown in FIGS. 19 and 21A-28B, except for cap portion 35 and secondary crankpin followers 43a and 43b. As shown in FIG. 29B, connecting rod 28 may include a single cap portion 35 that is coupled to first and second pairs of legs 37a, 37b, 39a, and 39b via, for example, fasteners such as bolts 45 (see FIG. 4). As shown, exemplary cap portion 35 includes an arc-shaped groove 54 receiving a secondary crankpin follower base 44 having a surface complementary to arc-shaped groove 54, such that follower base 44 may oscillate in groove 54. Secondary crankpin followers 43a and 43b are mounted at opposite ends of follower base 44, and thus, secondary crankpin followers 43a and 43b also oscillate with respect to cap portion 35. According to some embodiments (not shown), secondary crankpin follower base 44 may comprise two parts, with one of secondary crankpin followers 43a and 43b mounted on each of the two parts of follower base 44.

According to some embodiments, secondary crankpin followers 43a and 43b may include follower surfaces that are concave such that they provide a greater area of contact with the profiles of secondary crankpin cams 27a and 27b. For example, the follower surfaces may have a concave radius that corresponds to the largest convex radius of secondary crankpin cams 27a and 27b. According to some embodiments, the follower surfaces may have a concave radius that corresponds to the a radius of secondary crankpin cams 27a and 27b at the radial position at which the highest force is transmitted between the follower surfaces and secondary crankpin cams 27a and 27b.

According to some embodiments, follower base 44 includes an arc-shaped slot 56, and cap portion 35 includes a pin 58, such that as the surface of secondary crankpin cams 27a and 27b ride against and pass secondary crankpin followers 43a and 43b, followers 43a and 43b oscillate relative to cap portion 35, for example, as shown in FIGS. 30B, 31B, 32B, 33B, 34B, and 35B. This serves to maintain an increased area of contact between secondary crankpin followers 43a and 43b and the surfaces of secondary crankpin cams 27a and 27b, thereby reducing friction and/or wear of secondary crankpin cams 27a and 27b and/or secondary crankpin followers 43a and 43b. According to some embodiments (not shown), cap portion 35 includes an arc-shaped slot and follower base 44 includes a pin, such that as the surface of secondary crankpin pin cams 27a and 27b ride against and pass secondary crankpin followers 43a and 43b, secondary crankpin followers 43a and 43b oscillate relative to cap portion 35.

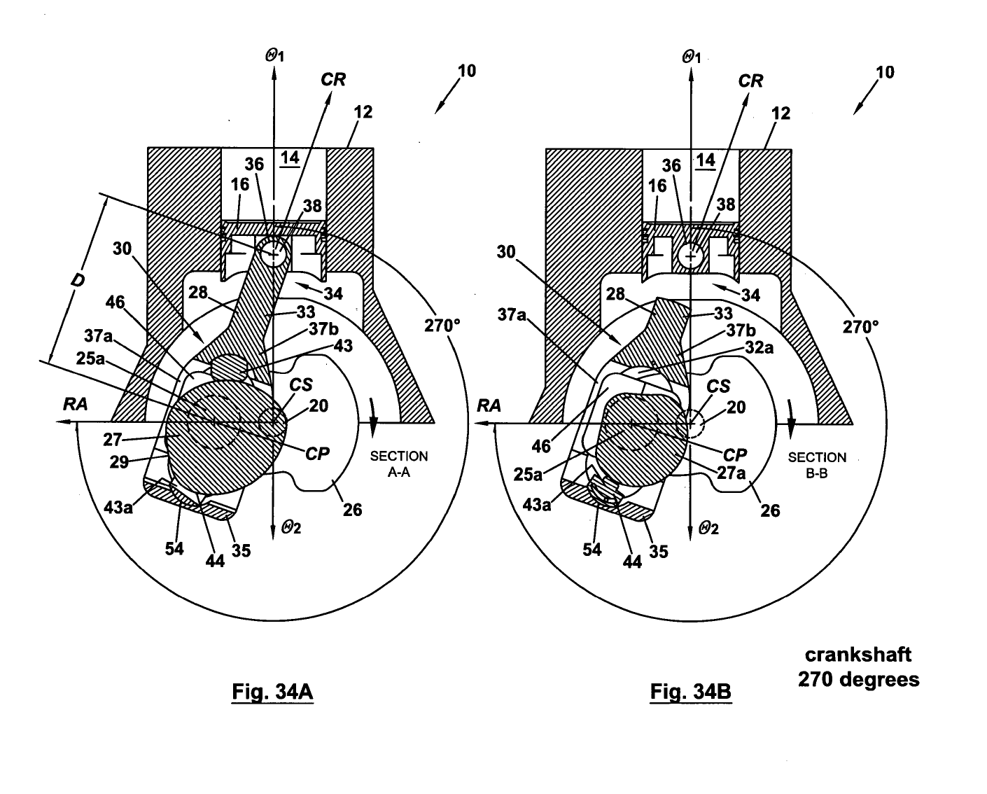

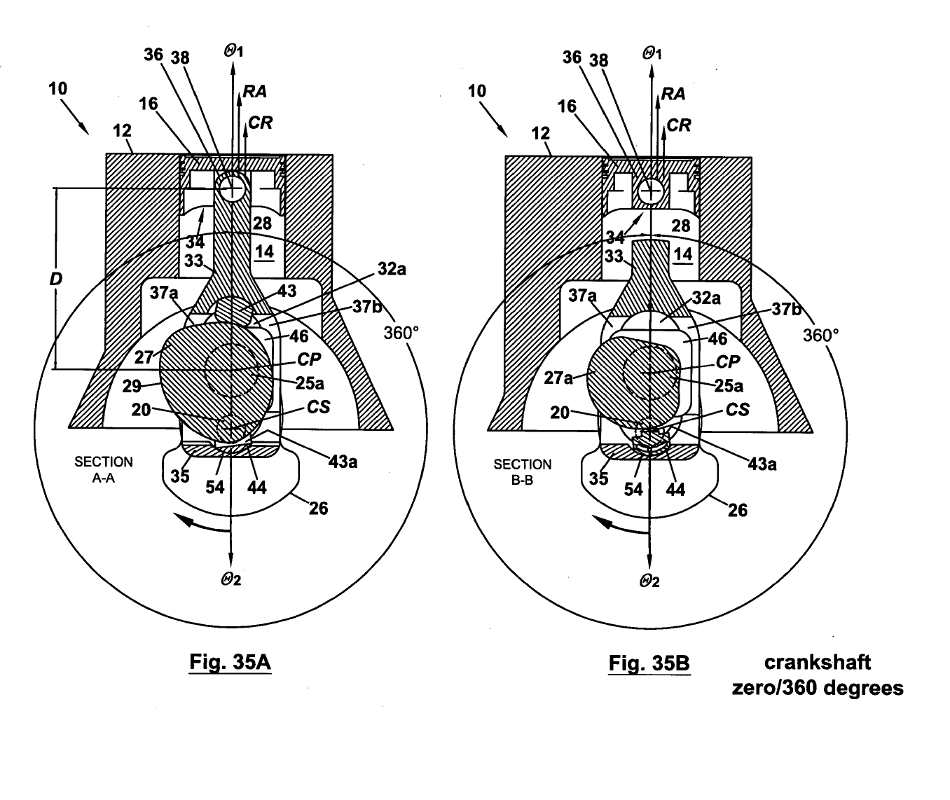

The exemplary engine 10 shown in FIGS. 30A-35B operates in a similar manner to the exemplary engine 10 shown in FIGS. 17-28B. (FIGS. 30A-35B are schematic section views, and thus, they may not show some of the subject matter identified in the descriptions of those figures, such as, for example, second pair of legs 39a and 39b, crankpin journal 25b, secondary crankpin cam 27b, and oblong opening 32b). In particular, the distance D between the center C of crankpin 24 and distal end 34 of connecting rod 28 is variable. More specifically, the distance D is variable, the variability of the distance D being facilitated in the exemplary embodiment by virtue of crankpin 24 and connecting rod 28. As radial axis RA rotates between first stroke termination angle θ₁ and 180 degrees past first stroke termination angle θ₁ (i.e., to second stroke termination angle θ₂), the distance D initially increases, thereby delaying initiation of the power stroke until radial axis RA reaches a point, for example, at least 40 degrees past first stroke termination angle θ₁ in the exemplary embodiment shown. Timing of the initiation of combustion may be tailored to take advantage of this delay. The distance D may remain relatively constant as radial axis RA continues to rotate toward an orientation 180 degrees past first stroke termination angle α, (FIGS. 30A-35B). As the radial axis RA rotates between 180 and 360 degrees past first stroke termination angle θ₁, the distance D decreases (FIGS. 34A-35B).

According to some embodiments, the exemplary configuration and/or interaction between crankshaft 20 and connecting rod 28 may be tailored to achieve desired performance characteristics of exemplary engine 10, such as, for example, improved efficiency, improved torque, improved power output, and/or improved responsiveness. For example, profile 29 of crankpin cam 27 may be configured to improve efficiency and/or power of exemplary engine 10, for example, by changing at least one of the timing and magnitude of the delay of initiation of the power stroke.

According to some embodiments, initiation of the power stroke of exemplary engine 10 may be delayed until radial axis RA has rotated at least about 15 degrees beyond the first stroke termination angle θ₁. In other embodiments, initiation of the power stroke may be delayed until radial axis RA has rotated at least about 30 degrees beyond the first stroke termination angle θ₁ (e.g., at least about 40 or 45 degrees beyond the first stroke termination angle θ₁). In other embodiments, rotation may be set to about 25 or 35 degrees beyond the first stroke termination angle θ₁, for example, to achieve a desired performance characteristic of engine 10.

According to some embodiments, depending on, for example, profile 29 of crankpin cam 27, piston 16 may continue to travel slightly up into cylinder 14 as radial axis RA rotates between 0 degrees and, for example, 40 degrees past first stroke termination angle θ₁, with the downward travel of piston 16 within cylinder 14 beginning thereafter at the end of the delay of the power stroke. In other words, during the delay of the power stroke, piston 16 is not necessarily stationary in cylinder 14, but rather, piston 16 may continue its upward travel in cylinder 14 relative to its position in cylinder 14 as radial axis RA passes 0 degrees relative to first stroke termination angle θ₁.

Cam profile 29 of crankpin cam 27 and/or the profiles of secondary crankpin cams 27a and 27b may be selected to facilitate a desired speed and/or acceleration of the travel of piston 16 within cylinder 14. For example, cam profile 29 of crankpin cam 27 may be configured to provide a relatively faster travel and/or higher acceleration following the end of the delay of the beginning of the power stroke. Such cam profile tailoring may be performed to provide a desired power, torque, and/or efficiency of engine 10. Cam profiles of secondary crankpin cams 27a and 27b may also be configured in a similar manner to achieve similar results.

According to some embodiments, engine 10 may be configured to selectively operate in at least two modes. For example, in a first mode of operation the distance D between the between the center C of crankpin 24 (e.g., the longitudinal axis CP of crankpin 24) and distal end 34 of connecting rod 28 may vary in a constant manner as described above. In a second mode of operation, the relationship between the profiles of cams 27, 27a, and/or 27b and crankpin 24 may be variable in a radial manner, such that the delay in the power stroke of piston 16 may be varied according to a desired tailoring. This may be accomplished via, for example, cam phasing, where cam 27 and/or secondary cams 27a and 27b may rotate relative to crankpin journals 25a and 25b, thereby changing the position of radial axis RA at which the power stroke begins. In this exemplary second mode of operation, it may be possible to tailor operation of engine 10 to vary the power output, torque, and/or efficiency of the operation of engine 10 according to operating parameters. According to some embodiments, engine 10 may operate according to a combination of the first and second modes.

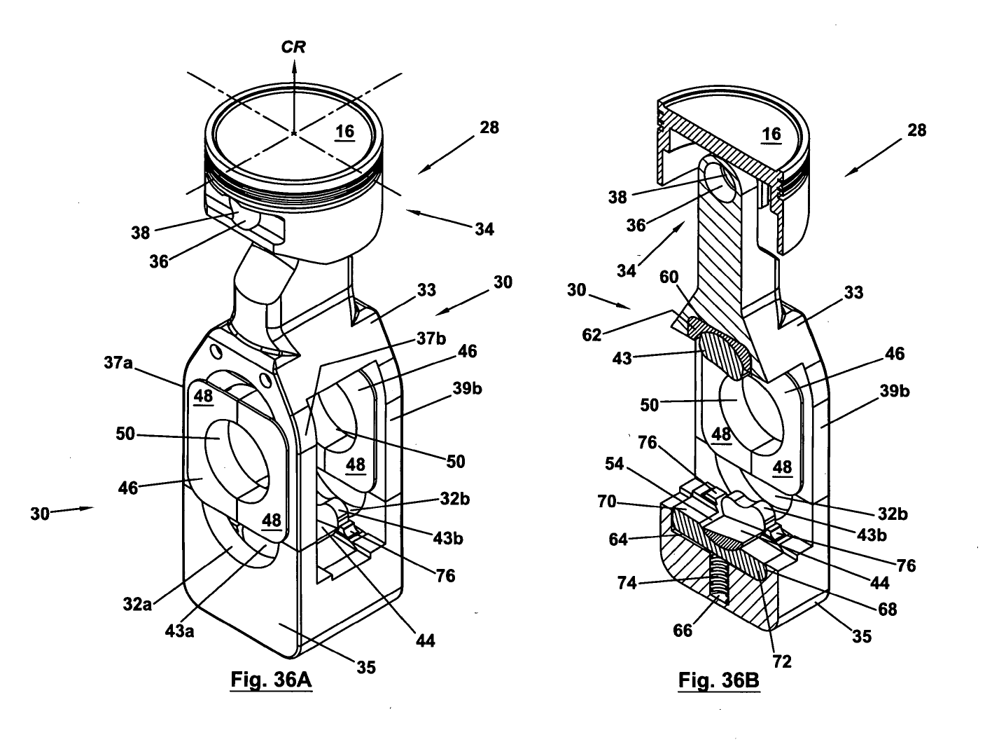

According to some embodiments, the followers 43, 43a, and/or 43b may be configured to reduce friction and/or wear of the followers and/or cams. For example, FIGS. 36A-42B show an exemplary connecting rod 28 that includes exemplary followers 43, 43a, and 43b, which may provide relatively reduced wear and/or friction as compared to the exemplary crankpin followers 43, 43a, and 43b shown in FIGS. 19 and 21A-28B.

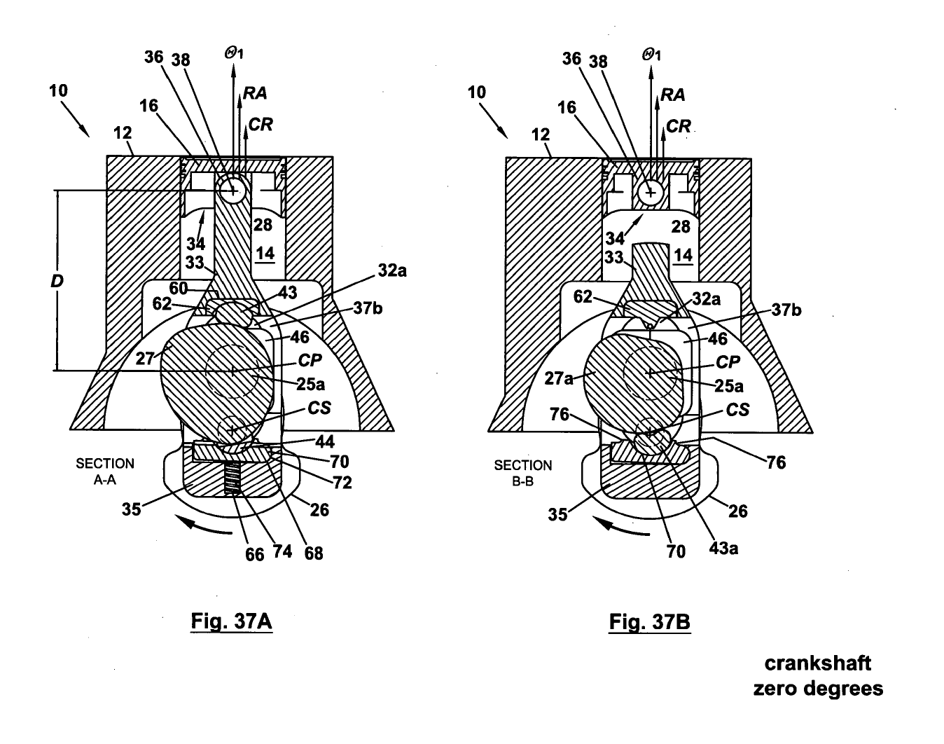

Referring to FIGS. 36A-37B, exemplary connecting rod 28 is similar to the exemplary connecting rod 28 shown in FIGS. 19 and 21A-28B, except for the arrangement of follower 43, cap portion 35, and secondary crankpin followers 43a and 43b. For example, as shown in FIG. 36B, proximal end 30 of rod portion 33 includes a recess 60, which receives an insert 62 against which follower 43 slides. According to this exemplary embodiment, follower 43 may be coupled to insert 62 in a manner, for example, similar to the manner in which follower 43 described with respect to FIGS. 21A-28B is coupled to rod portion 33 (e.g., via a pin and groove arrangement). By virtue of follower 43 being coupled to insert 62 rather than directly to rod portion 33, a follower having a different geometry may be exchanged in connecting rod 28 without changing larger portions of connecting rod 28 or the entire connecting rod 28. For example, an assembly including a combination of follower 43 and insert 62 may be exchanged for a similar assembly having follower/insert combination that results in different delaying strategies for the stroke of piston 16.

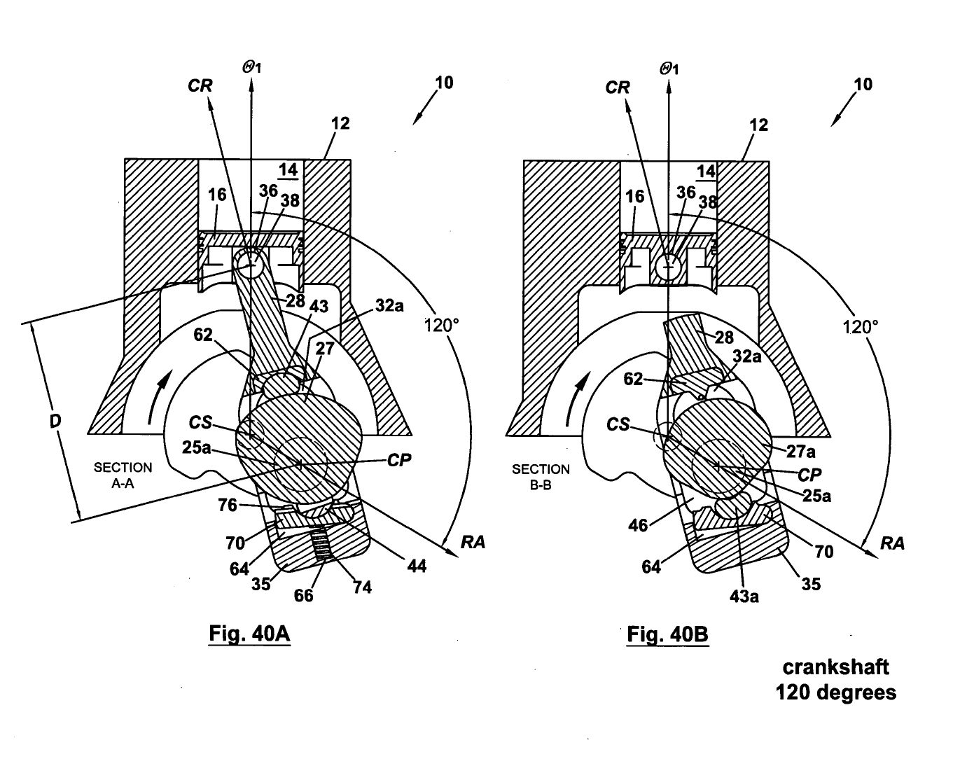

As shown in FIG. 36B, connecting rod 28 may include a single cap portion 35 that is coupled to first and second pairs of legs 37a, 37b, 39a, and 39b via, for example, fasteners such as bolts 45 (see FIG. 4). As shown, exemplary cap portion 35 includes a cap recess 64 having a cavity 66 (e.g., a bore). In the exemplary embodiment shown, cap recess 64 includes one end 68 having an arc-shaped face, and cap recess 64 receives a rocker member 70 having one end with a surface 72 that is arc-shaped in a complimentary manner with respect to end 68 of cap recess 64 to facilitate movement, such as an oscillating motion, between rocker member 70 and cap portion 35. A biasing member 74 may be provided in cavity 66 to bias rocker member 70, such that it pivots out with respect to cap recess 64 of cap portion 35 (see, e.g., FIG. 40A). Biasing member 74 may include any known biasing arrangement, such as, for example, a spring and/or hydraulic assembly.

According to some embodiments, rocker member 70 may include a groove 54 (e.g., having an arc-shaped cross-section) receiving a secondary crankpin follower base 44 having a surface complementary to groove 54, such that follower base 44 may oscillate or otherwise generally move in groove 54. Secondary crankpin followers 43a and 43b are mounted at opposite ends of follower base 44, and thus, secondary crankpin followers 43a and 43b also oscillate or otherwise generally move with respect to cap portion 35. In the exemplary embodiment shown, rocker member 70 includes ears 76, which serve to extend the surface of groove 54 and may provide more control of the motion of secondary crankpin follower base 44. According to some embodiments (not shown), secondary crankpin follower base 44 may comprise two parts, with one of secondary crankpin followers 43a and 43b mounted on each of the two parts of secondary crankpin follower base 44.

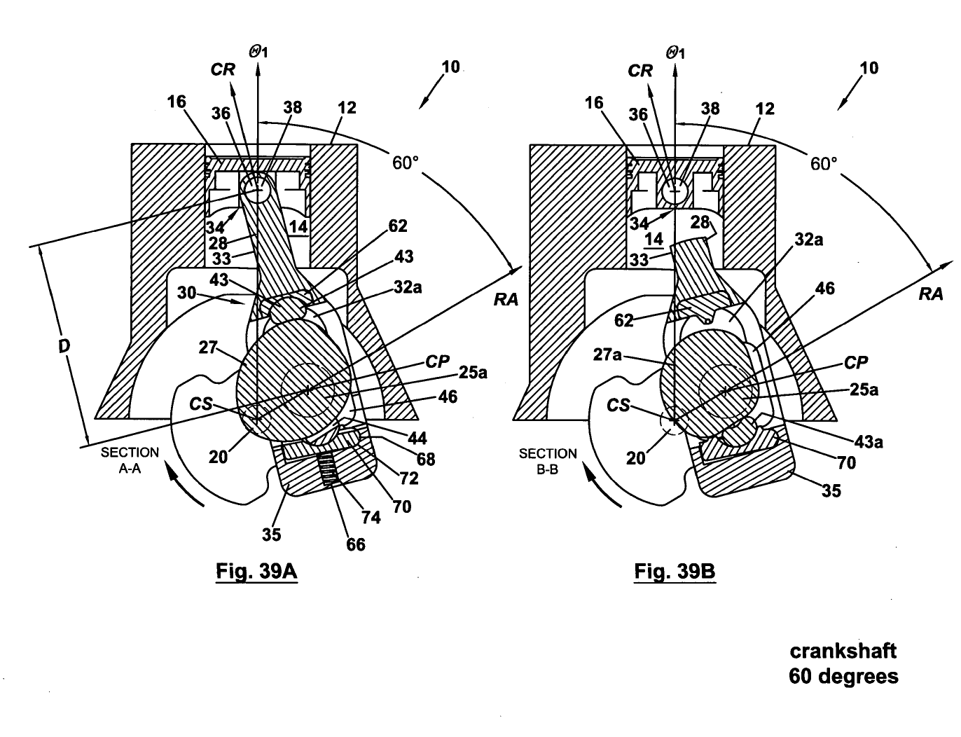

Exemplary rocker member 70 may serve to substantially maintain contact between respective secondary crankpin cams 27a and 27b and secondary crankpin followers 43a and 43b. For example, as shown in FIGS. 39B, 40B, and 41B, rocker member 70 pivots with respect to cap portion 35, with biasing member 74 (see FIGS. 39A, 40A, and 41A) providing a biasing force to hold secondary crankpin followers 43a and 43b against respective secondary crankpin cams 27a and 27b. This may result in reduced friction, wear, and/or noise during operation of engine 10.

According to some embodiments, secondary crankpin followers 43a and 43b may include follower surfaces that are concave such that they provide a greater area of contact with the profiles of secondary crankpin cams 27a and 27b. For example, the follower surfaces may have a concave radius that corresponds to the smallest convex radius of secondary crankpin cams 27a and 27b, for example, when radial axis RA is, for example, between about 60 and 120 degrees (e.g., about 90 degrees) past first stroke termination angle θ₁. According to some embodiments, the follower surfaces of secondary crankpin followers 43a and 43b may be configured such that they contact secondary crankpin cams 27a and 27b at at least two discrete contact points (see, e.g., FIGS. 37B, 38B, and 39B). This may serve to reduce friction and/or wear between secondary crankpin cams 27a and 27b and second crankpin followers 43a and 43b. According to some embodiments, the follower surfaces may have a concave radius that corresponds to the radius of secondary crankpin cams 27a and 27b at the radial position at which the highest force is transmitted between the follower surfaces and secondary crankpin cams 27a and 27b.

According to some embodiments, as the surfaces of secondary crankpin cams 27a and 27b ride against and pass secondary crankpin followers 43a and 43b, followers 43a and 43b oscillate relative to cap portion 35, for example, as shown in FIGS. 37B, 38B, 39B, 40B, 41B, and 42B. This serves to maintain an increased area of contact between secondary crankpin followers 43a and 43b and the surfaces of secondary crankpin cams 27a and 27b, thereby reducing friction and/or wear of secondary crankpin cams 27a and 27b and/or secondary crankpin followers 43a and 43b.

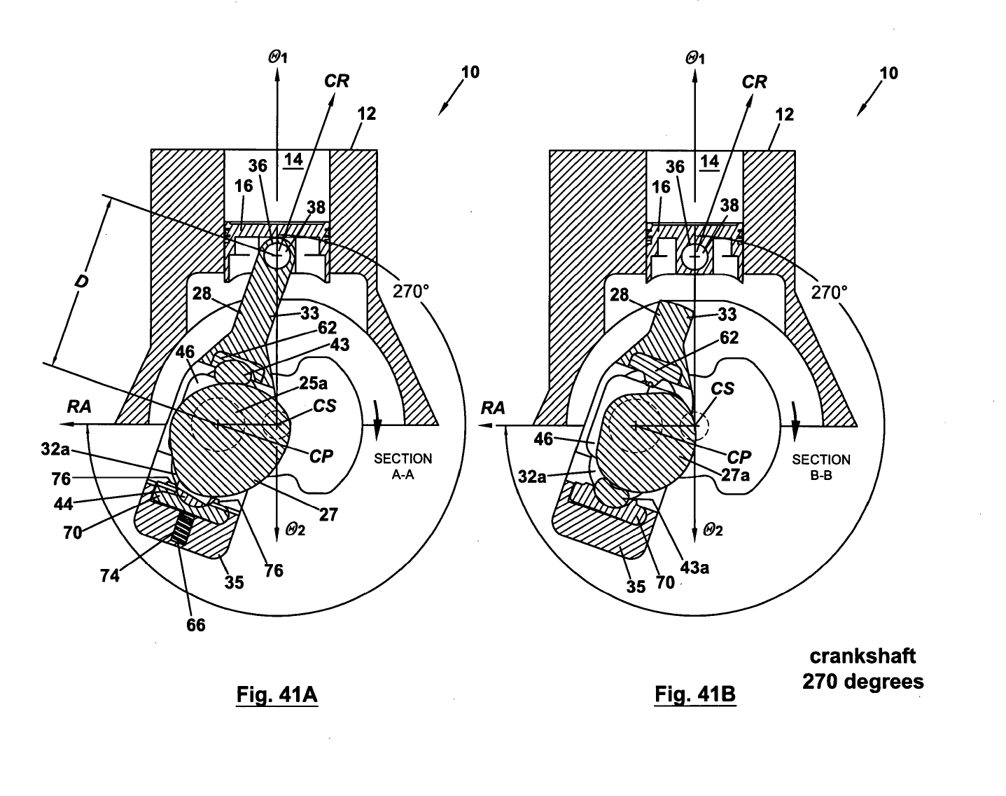

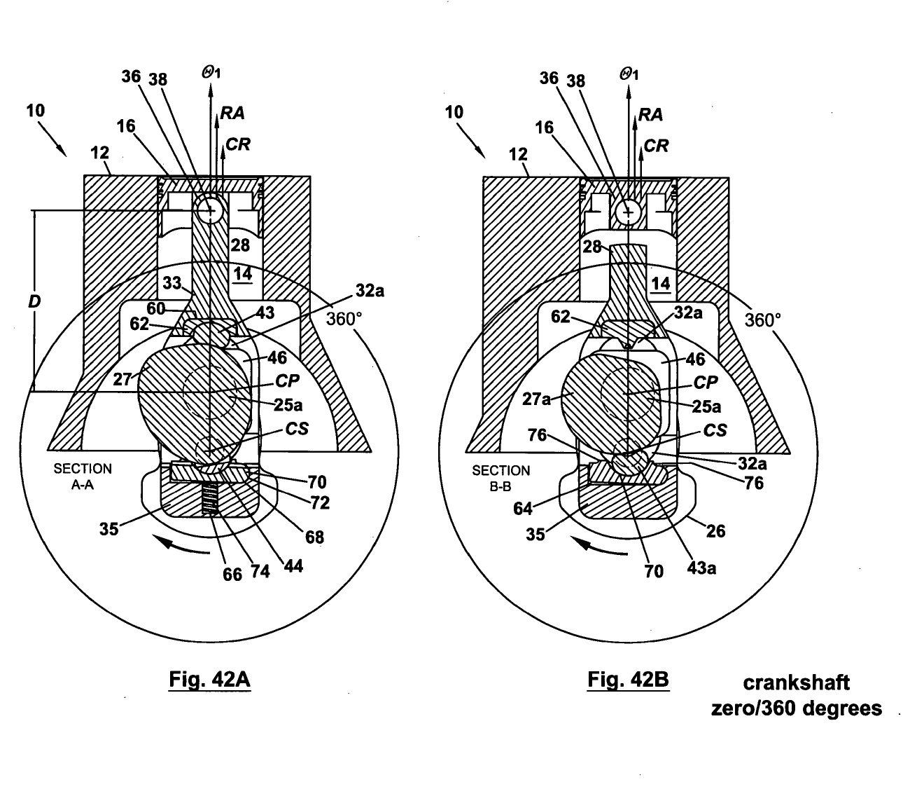

The exemplary engine 10 shown in FIGS. 36A-42B operates in a similar manner to the exemplary engine 10 shown in FIGS. 17-28B. (FIGS. 37A-42B are schematic section views, and thus, they may not show some of the subject matter identified in the descriptions of those figures, such as, for example, second pair of legs 39a and 39b, crankpin journal 25b, secondary crankpin cam 27b, and oblong opening 32b). In particular, the distance D between the center C of crankpin 24 and distal end 34 of connecting rod 28 is variable. More specifically, the distance D is variable, the variability of the distance D being facilitated in the exemplary embodiment by virtue of crankpin 24 and connecting rod 28. As radial axis RA rotates between first stroke termination angle θ₁ and 180 degrees past first stroke termination angle θ₁ (i.e., to second stroke termination angle θ₂), the distance D initially increases, thereby delaying initiation of the power stroke until radial axis RA reaches a point, for example, at least 40 degrees past first stroke termination angle θ₁ in the exemplary embodiment shown. Timing of the initiation of combustion may be tailored to take advantage of this delay. The distance D may remain relatively constant as radial axis RA continues to rotate toward an orientation 180 degrees past first stroke termination angle θ₁ (FIGS. 30A-35B). As the radial axis RA rotates between 180 and 360 degrees past first stroke termination angle θ₁, the distance D decreases (FIGS. 41A-42B).

According to some embodiments, the exemplary configuration and/or interaction between crankshaft 20 and connecting rod 28 may be tailored to achieve desired performance characteristics of exemplary engine 10, such as, for example, improved efficiency, improved torque, improved power output, and/or improved responsiveness. For example, profile 29 of crankpin cam 27 may be configured to improve efficiency and/or power of exemplary engine 10, for example, by changing at least one of the timing and magnitude of the delay of initiation of the power stroke.

According to some embodiments, initiation of the power stroke of exemplary engine 10 may be delayed until radial axis RA has rotated at least about 15 degrees beyond the first stroke termination angle θ₁. In other embodiments, initiation of the power stroke may be delayed until radial axis RA has rotated at least about 30 degrees beyond the first stroke termination angle θ₁ (e.g., at least about 40 or 45 degrees beyond the first stroke termination angle θ₁). In other embodiments, rotation may be set to about 25 or 35 degrees beyond the first stroke termination angle θ₁, for example, to achieve a desired performance characteristic of engine 10.

According to some embodiments, depending on, for example, profile 29 of crankpin cam 27, piston 16 may continue to travel slightly up into cylinder 14 as radial axis RA rotates between 0 degrees and, for example, 40 degrees past first stroke termination angle θ₁, with the downward travel of piston 16 within cylinder 14 beginning thereafter at the end of the delay of the power stroke. In other words, during the delay of the power stroke, piston 16 is not necessarily stationary in cylinder 14, but rather, piston 16 may continue its upward travel in cylinder 14 relative to its position in cylinder 14 as radial axis RA passes 0 degrees relative to first stroke termination angle θ₁.

Cam profile 29 of crankpin cam 27 and/or the profiles of secondary crankpin cams 27a and 27b may be selected to facilitate a desired speed and/or acceleration of the travel of piston 16 within cylinder 14. For example, cam profile 29 of crankpin cam 27 may be configured to provide a relatively faster travel and/or higher acceleration following the end of the delay of the beginning of the power stroke. Such cam profile tailoring may be performed to provide a desired power, torque, and/or efficiency of engine 10. Cam profiles of secondary crankpin cams 27a and 27b may also be configured in a similar manner to achieve similar results.

According to some embodiments, engine 10 may be configured to selectively operate in at least two modes. For example, in a first mode of operation the distance D between the between the center C of crankpin 24 (e.g., the longitudinal axis CP of crankpin 24) and distal end 34 of connecting rod 28 may vary in a constant manner as described above. In a second mode of operation, the relationship between the profiles of cams 27, 27a, and/or 27b and crankpin 24 may be variable in a radial manner, such that the delay in the power stroke of piston 16 may be varied according to a desired tailoring. This may be accomplished via, for example, cam phasing, where cam 27 and/or secondary cams 27a and 27b may rotate relative to crankpin journals 25a and 25b, thereby changing the position of radial axis RA at which the power stroke begins. In this exemplary second mode of operation, it may be possible to tailor operation of engine 10 to vary the power output, torque, and/or efficiency of the operation of engine 10 according to operating parameters. According to some embodiments, engine 10 may operate according to a combination of the first and second modes.

Exemplary engines 10 shown in FIGS. 16-42B may be incorporated into a power train, for example, including a transmission operably coupled to engine 10 and a drive member configured to perform work, the drive member being operably coupled to the transmission. For example, the drive member may include a propulsion device, such as, for example, a wheel or a propeller. According to some embodiments, such a power train may include a generator configured to convert rotational power into electrical power, the generator being operably coupled to exemplary engine 10. Such a power train may include a power storage device (e.g., a flywheel and/or one or more batteries) operably coupled to the generator and configured to store electrical power. According to some embodiments, the transmission may include one or more electric motors.

Moreover, exemplary engines 10 may be incorporated into a vehicle including a transmission operably coupled to engine 10 and a drive member configured to perform work and being operably coupled to the transmission. For example, the drive member may include a propulsion device, such as, for example, a wheel or a propeller. For example, the vehicle may be a car, van, truck, boat, ship, train, or air vehicle. Such a vehicle may include exemplary engine 10 operably coupled to a generator configured to convert rotational power into electrical power, and a power storage device operably coupled to the generator and configured to store electrical power. The transmission may be, for example, an electric motor.

At least some portions of exemplary embodiments of the systems outlined above may used in association with portions of other exemplary embodiments. Moreover, at least some of the exemplary embodiments disclosed herein may be used independently from one another and/or in combination with one another and may have applications to internal combustion engines not disclosed herein.

It will be apparent to those skilled in the art that various modifications and variations can be made to the structures and methodologies described herein. Thus, it should be understood that the invention is not limited to the subject matter discussed in the description. Rather, the present invention is intended to cover modifications and variations.

1-94. (canceled)

95. An internal combustion engine comprising:
a cylinder block defining a cylinder;
a crankshaft comprising a crankpin, wherein the crankshaft is rotatably coupled to the cylinder block and rotates along a longitudinal crankshaft axis, and the crankpin defines a longitudinal crankpin axis parallel to and spaced from the longitudinal crankshaft axis;
a piston configured to reciprocate within the cylinder; and
a connecting rod comprising a proximal end and a distal end, wherein the proximal end is operably coupled to the crankpin and the distal end is operably coupled to the piston,
wherein the crankpin and connecting rod are configured to provide relative linear movement between the longitudinal crankpin axis and the proximal end of the connecting rod.

96. The internal combustion engine of claim 95, wherein the proximal end of the connecting rod comprises an oblong opening, and the crankpin is received in the oblong opening, and wherein the crankpin and the connecting rod are configured such that the crankpin moves along a longitudinal axis of the oblong opening.

97. The internal combustion engine of claim 96, wherein the crankpin comprises at least one cam and the connecting rod comprises a follower, such that the movement along the oblong opening is based on interaction between the at least one cam and the follower.

98. The internal combustion engine of claim 97, wherein the crankpin comprises at least one crankpin journal and the at least one cam, and the at least one crankpin journal is received within the oblong opening.

99. The internal combustion engine of claim 98, wherein the at least one crankpin journal comprises two crankpin journals separated by the at least one cam.

100. The internal combustion engine of claim 99, wherein the connecting rod comprises a first pair of legs and a second pair of legs spaced from the first pair of legs and providing a clearance between the first and second pairs of legs, wherein the first and second pairs of legs at least partially define a first oblong opening and a second oblong opening, and wherein a first crankpin journal is received in the first oblong opening, and a second crankpin journal is received in the second oblong opening.

101. The internal combustion engine of claim 100, wherein the connecting rod comprises a first cap portion coupled to the first pair of legs and a second cap portion coupled to the second pair of legs, and wherein the first cap portion and the first pair of legs defines the first oblong opening and the second cap portion and the second pair of legs defines the second oblong opening.

102. The internal combustion engine of claim 100, wherein the follower is associated with the clearance.

103. The internal combustion engine of claim 95, wherein crankpin comprises at least one cam comprising a cam profile, and wherein the crankpin comprises at least one crankpin journal and the at least one cam, and the at least one cam is associated with the at least one crankpin journal.

104. The internal combustion engine of claim 103, wherein the at least one crankpin journal comprises two crankpin journals, and the two crankpin journals are separated by the at least one cam.

105. The internal combustion engine of claim 103, wherein the connecting rod comprises a follower, and the cam profile and follower are configured to provide the relative linear movement between the longitudinal crankpin axis and the proximal end of the connecting rod.

106. The internal combustion engine of claim 95, wherein the crankpin comprises at least one crankpin journal and at least one cam comprising a cam profile, and wherein the cam profile is configured to affect a stroke of the piston.

107. The internal combustion engine of claim 106, wherein the cam profile defines a radial distance from the longitudinal crankpin axis to an edge face of the cam, wherein the radial distance varies from a minimum radial distance to a maximum radial distance, and wherein in a first direction extending along a line from the longitudinal crankshaft axis toward the longitudinal crankpin axis, the radial distance associated with the first direction is less than the maximum radial distance.

108. The internal combustion engine of claim 107, wherein in a second direction extending along a line from the longitudinal crankpin axis toward the longitudinal crankshaft axis, the radial distance associated with the second direction is greater than the radial distance associated with the first direction.

109. The internal combustion engine of claim 96, wherein the connecting rod comprises a rod portion and a cap portion, and wherein the rod portion and the cap portion define the oblong opening, and wherein an end of the oblong opening is associated with a follower.

110. The internal combustion engine of claim 109, wherein the rod portion comprises the follower.

111. The internal combustion engine of claim 96, wherein the oblong opening has a width corresponding to a diameter of a crankpin journal.

112. The internal combustion engine of claim 97, wherein the at least one cam comprises two cams, wherein a first cam of the two cams comprises a first cam profile and a second cam of the two cams comprises a second cam profile, and wherein the first and second cam profiles differ from one another.

113. The internal combustion engine of claim 112, wherein the crankpin comprises two crankpin journals, and wherein the first and second cams are between the two crankpin journals.

114. The internal combustion engine of claim 97, wherein the at least one cam comprises three cams, wherein a first cam of the three cams comprises a first cam profile and a second cam and a third cam of the two cams comprises a second cam profile, and wherein the first cam profile and the second cam profile differ from one another.

115. The internal combustion engine of claim 114, wherein the crankpin comprises two crankpin journals, wherein the first, second, and third cams are between the two crankpin journals, and wherein the first cam is between the second and third cams.

116. The internal combustion engine of claim 97, wherein the follower is configured to oscillate with respect to the connecting rod.

117. The internal combustion engine of claim 116, wherein the connecting rod comprises a rod portion, and the rod portion comprises a first pair of legs at least partially defining one end of the oblong opening, and a second pair of legs spaced from the first pair of legs, thereby providing a clearance between the first pair of legs and the second pair of legs, and wherein the follower is associated with an end of the clearance.

118. The internal combustion engine of claim 117, wherein the connecting rod comprises a cap portion coupled to the first and second pairs of legs.

119. The internal combustion engine of claim 117, wherein the follower comprises a follower surface having a concave radius.

120. The internal combustion engine of claim 119, wherein the at least one cam comprises a cam profile, wherein at least a portion of the cam profile comprises a convex radius, and wherein the concave radius of the follower is substantially the same as a portion of the convex radius.

121. The internal combustion engine of claim 97, wherein a second end of the oblong opening is associated with at least one secondary follower configured to follow a cam.

122. The internal combustion engine of claim 121, wherein the connecting rod comprises a cap portion, and wherein the at least one secondary follower is associated with the cap portion.

123. The internal combustion engine of claim 122, wherein the at least one secondary follower is configured to oscillate with respect to the cap portion.

124. The internal combustion engine of claim 122, wherein the at least one secondary follower comprises two secondary followers.

125. The internal combustion engine of claim 122, wherein the at least one secondary follower comprises a follower surface having a concave radius.

126. The internal combustion engine of claim 125, wherein the crankpin comprises at least one secondary cam comprising a secondary cam profile, and a portion of the secondary cam profile has a convex radius, and wherein the concave radius of the secondary follower is substantially the same as a portion of the convex radius.

127. The internal combustion engine of claim 97, further comprising a sleeve received in the oblong opening, wherein the sleeve receives the crankpin and is configured to reciprocate within the oblong opening.

128. An internal combustion engine comprising:
a cylinder block defining a cylinder;
a crankshaft comprising a crankpin, wherein the crankshaft is rotatably coupled to the cylinder block and rotates along a longitudinal crankshaft axis, and the crankpin defines a longitudinal crankpin axis parallel to and offset by a distance with respect to the longitudinal crankshaft axis;
a piston configured to reciprocate within the cylinder between spaced stroke termination points defining a stroke of the piston; and
a connecting rod comprising a proximal end and a distal end, wherein the proximal end is operably coupled to the crankpin and the distal end is operably coupled to the piston,
wherein a line extending between the longitudinal crankshaft axis and the longitudinal crankpin axis defines a radial axis of the crankshaft,
wherein the crankpin and the proximal end of the connecting rod are configured to vary a distance between the longitudinal crankpin axis and the distal end of the connecting rod, and
wherein the engine is configured such that as the crankshaft rotates, reversal of the direction of travel of the piston within the cylinder is delayed via relative motion between the longitudinal crankpin axis and the proximal end of the connecting rod after the piston reaches at least one of the stroke termination points.

129. The internal combustion engine of claim 128, wherein the reversal of the direction of travel of the piston within the cylinder is delayed until the radial axis of the crankshaft has rotated at least about 10 degrees past a point corresponding to the at least one stroke termination point.

130. The internal combustion engine of claim 128, wherein the reversal of the direction of travel of the piston within the cylinder is delayed until the radial axis of the crankshaft has rotated at least about 20 degrees past a point corresponding to the at least one stroke termination point.

131. The internal combustion engine of claim 128, wherein the reversal of the direction of travel of the piston within the cylinder is delayed until the radial axis of the crankshaft has rotated at least about 30 degrees past a point corresponding to the at least one stroke termination point.

132. The internal combustion engine of claim 128, wherein the reversal of the direction of travel of the piston within the cylinder is delayed until the radial axis of the crankshaft has rotated at least about 40 degrees past a point corresponding to the at least one stroke termination point.

133. An internal combustion engine comprising:
a cylinder block defining a cylinder;
a crankshaft comprising a crankpin, wherein the crankshaft is rotatably received by the cylinder block and rotates along a longitudinal crankshaft axis, and the crankpin defines a longitudinal crankpin axis parallel to and offset by a distance with respect to the longitudinal crankshaft axis;
a piston configured to reciprocate within the cylinder; and
a connecting rod comprising a proximal end and a distal end, wherein the proximal end is operably coupled to the crankpin and the distal end is operably coupled to the piston,
wherein a line extending between the longitudinal crankshaft axis and the longitudinal crankpin axis defines a radial axis of the crankshaft,
wherein the crankpin and the proximal end of the connecting rod are configured to vary a distance between the longitudinal crankpin axis and the distal end of the connecting rod, and
wherein the engine is configured to selectively operate in two modes, comprising:
a first mode, wherein the distance between the longitudinal crankpin axis and the distal end of the connecting rod varies according to a first strategy based on the radial position of the radial axis of the crankshaft, and
a second mode, wherein the distance between the longitudinal crankpin axis and the distal end of the connecting rod varies according to a second strategy based on the radial position of the radial axis of the crankshaft,
wherein the first strategy differs from the second strategy.

134. A power train comprising:
the internal combustion engine according to claim 95;
a transmission operably coupled to the engine;
a drive member configured to perform work, the drive member being operably coupled to the transmission;
a generator configured to convert rotational power into electrical power, the generator being operably coupled to the internal combustion engine; and
a power storage device configured to store electrical power, the power storage device being operably coupled to the generator,
wherein the transmission comprises an electric motor.
